(19) United States
(12) Patent Application Publication
(10) Pub. No.: US 2025/0212019 A1
(43) Pub. Date: Jun. 26, 2025

(54) PREDICTIVE RESOURCE MANAGEMENT USING USER EQUIPMENT INFORMATION IN A MACHINE LEARNING MODEL

(71) Applicant: QUALCOMM INCORPORATED, San Diego, CA (US)

(72) Inventors: Qiaoyu Li, Beijing (CN); Mahmoud Taherzadeh Boroujeni, San Diego, CA (US); Arumugam Chendamarai Kannan, San Diego, CA (US); Tao Luo, San Diego, CA (US)

(21) Appl. No.: 18/844,328

(22) PCT Filed: May 7, 2022
(86) PCT No.: PCT/CN2022/091407

§ 371 Date: Sep. 5, 2024

(51) Int. Cl. H04W 24/02; H04B 7/06; H04B 17/318; H04W 72/044

(52) U.S. Cl. CPC H04W 24/02; H04B 7/0626; H04B 17/328; H04W 72/046

(57) ABSTRACT

Methods, systems, and devices for wireless communication at a user equipment (UE) are described. A UE may enhance channel state information (CSI)-reference signal (RS) reports to allow receive beam information and associated transmit beam channel characteristics to be transmitted back to a network entity for training a machine learning model. In some examples, the UE may perform implicit reporting of a receive beam by using additional channel measurement resources or sounding reference signal (SRS) resources to associate with different receive beam options such that the UE may avoid disclosing antenna or beaming implementations or causing the network entity to train the machine learning model too diversely. Additionally, or alternatively, the UE may explicitly report the receive beam quantities. In some examples, the network entity may transmit the machine learning model to the UE so that the UE may also perform receive beam prediction.

### CROSS REFERENCE

The present Application is a 371 national stage filing of International PCT Application No. PCT/CN2022/091407 by Li et al. entitled “PREDICTIVE RESOURCE MANAGEMENT USING USER EQUIPMENT INFORMATION IN A MACHINE LEARNING MODEL,” filed May 7, 2022, which is assigned to the assignee hereof, which is expressly incorporated by reference in its entirety herein.

### TECHNICAL FIELD

The following relates to wireless communication at a user equipment (UE), including predictive resource management using UE information in a machine learning model.

### DESCRIPTION OF THE RELATED TECHNOLOGY

Wireless communication systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems, which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

Wireless communication systems may support beam sweeping procedures for selecting a beam for communication between a UE and a network entity (for example, a base station or one of multiple components arranged in a disaggregated architecture). The UE may select one or more beams to receive or transmit information by measuring and comparing channel characteristics using a reference signal resource for each beam, such as a synchronization signal block (SSB) or a channel state information reference signal (CSI-RS), among other examples. The network entity and the UE may employ machine learning models in managing the reference signal resources, but the UE is limited by the information that the UE can use in managing the reference signal resources.

### SUMMARY

The systems, methods, and devices of this disclosure each have several innovative aspects, no single one of which is solely responsible for the desirable attributes disclosed herein.

A method for wireless communication at a user equipment (UE) is described. The method may include transmitting a set of multiple reference signals indicating information associated with a first set of channel measurement resources, a second set of channel measurement resources, and a direction of reception for communications, the information corresponding to a receive beam at the UE corresponding to the direction of reception for the communications, receiving, based on transmitting the set of multiple reference signals, signaling indicating a machine learning model for obtaining a channel characteristic prediction associated with the first set of channel measurement resources, the machine learning model based on the receive beam at the UE, inputting, to the machine learning model, an input to obtain the channel characteristic prediction, and receiving signaling based on obtaining the channel characteristic prediction associated with the first set of channel measurement resources.

Some examples of the method, apparatuses, and non-transitory computer-readable medium described herein may further include operations, features, means, or instructions for determining the receive beam for the UE corresponding to the direction of reception for the communications based on one or more channel measurement resource identifiers corresponding to the second set of channel measurement resources and one or more first channel characteristics associated with the second set of channel measurement resources, where the information includes the one or more first channel characteristics and transmitting the one or more channel measurement resource identifiers in a same signal as a subset of the set of multiple reference signals associated with the second set of channel measurement resources, where the receiving the signaling may be based on transmitting the one or more channel measurement resource identifiers.

In some examples of the method, apparatuses, and non-transitory computer-readable medium described herein, inputting, to the machine learning model based on transmitting the set of multiple reference signals, the one or more channel measurement resource identifiers, one or more second channel characteristics associated with the first set of channel measurement resources, or both and obtaining the channel characteristic prediction associated with the first set of channel measurement resources based on inputting the one or more channel measurement resource identifiers, the one or more second channel characteristics associated with the first set of channel measurement resources, or both.

A method for wireless communication at a network entity is described. The method may include receiving a set of multiple reference signals indicating information corresponding to one or more channel characteristics associated with a first set of channel measurement resources, a second set of channel measurement resources, and a direction of reception for communications, the information corresponding to a receive beam at a UE corresponding to the direction of reception for the communications, training a machine learning model for obtaining a channel characteristic prediction associated with the first set of channel measurement resources based on inputting the one or more channel characteristics associated with the first set of channel measurement resources, the second set of channel measurement resources, and the direction of reception for communications to the machine learning model to obtain the channel characteristic prediction associated with the first set of channel measurement resources, the one or more channel characteristics based on the receive beam at the UE, and transmitting signaling indicating the machine learning model based on training the machine learning model.

Some examples of the method, apparatuses, and non-transitory computer-readable medium described herein may further include operations, features, means, or instructions for receiving, in a same signal as a subset the set of multiple reference signals associated with the second set of channel measurement resources, one or more channel measurement resource identifiers associated with the second set of channel measurement resources and determining the receive beam at the UE for measuring the first set of channel measurement resources based on the one or more channel measurement resource identifiers.

A method for wireless communication at a UE is described. The method may include transmitting information associated with one or more channel measurement resources and a direction of reception for communications, receiving signaling indicating a machine learning model for obtaining a channel characteristic prediction associated with the one or more channel measurement resources based on transmitting the information, inputting, to the machine learning model, an input to obtain the channel characteristic prediction associated with the one or more channel measurement resources, and receiving signaling based on obtaining the channel characteristic prediction associated with the one or more channel measurement resources.

In some examples of the method, apparatuses, and non-transitory computer-readable medium described herein, inputting, to the machine learning model, one or more channel characteristics associated with the one or more channel measurement resources, the transmitted information, or both and obtaining the channel characteristic prediction associated with the one or more channel measurement resources, the transmitted information, or both based on the inputting.

A method for wireless communication at a network entity is described. The method may include receiving information associated with one or more channel measurement resources and a direction of reception for communications at a UE, training a machine learning model for obtaining a channel characteristic prediction based on inputting one or more channel characteristics and the information to the machine learning model to obtain the channel characteristic prediction, and transmitting signaling indicating the machine learning model based on training the machine learning model.

An apparatus for wireless communication at a network entity is described. The apparatus may include a processor, memory coupled with the processor, and instructions stored in the memory. The instructions may be executable by the processor to cause the apparatus to receive information associated with one or more channel measurement resources and a direction of reception for communications at a UE, train a machine learning model for obtaining a channel characteristic prediction based on inputting one or more channel characteristics and the information to the machine learning model to obtain the channel characteristic prediction, and transmit signaling indicating the machine learning model based on training the machine learning model.

### BRIEF DESCRIPTION OF THE DRAWINGS

FIG. 1 illustrates an example of a wireless communication system that supports predictive resource management using user equipment (UE) information in a machine learning model in accordance with one or more aspects of the present disclosure.

FIG. 2 illustrates an example of a wireless communication system that supports predictive resource management using UE information in a machine learning model in accordance with one or more aspects of the present disclosure.

FIG. 3 illustrates an example of a process flow that supports predictive resource management using UE information in a machine learning model in accordance with one or more aspects of the present disclosure.

FIG. 4 illustrates an example of a process flow that supports predictive resource management using UE information in a machine learning model in accordance with one or more aspects of the present disclosure.

FIGS. 5-7 show block diagrams that support predictive resource management using UE information in a machine learning model in accordance with one or more aspects of the present disclosure.

FIG. 8 shows a diagram of a system including a device that supports predictive resource management using UE information in a machine learning model in accordance with one or more aspects of the present disclosure.

FIGS. 9-11 show block diagrams that support predictive resource management using UE information in a machine learning model in accordance with one or more aspects of the present disclosure.

FIG. 12 shows a diagram of a system including a device that supports predictive resource management using UE information in a machine learning model in accordance with one or more aspects of the present disclosure.

FIGS. 13-20 show flowcharts illustrating methods that support predictive resource management using UE information in a machine learning model in accordance with one or more aspects of the present disclosure.

### DETAILED DESCRIPTION

Wireless communication systems may support beam sweeping procedures for selecting one or more beams for communication between a user equipment (UE) and a network entity (for example, a base station or one of multiple components arranged in a disaggregated architecture). A UE may select the one or more beams to receive or transmit information by measuring and comparing channel characteristics using a reference signal resource for each beam, such as a synchronization signal block (SSB) or a channel state information reference signal (CSI-RS), among other examples. A network entity may employ a machine learning model to predict whether a top beam index (for example, a strongest beam index of a group of beam indices) may change based on different inputs (for example, measured channel characteristics). In some examples, the machine learning model may be able to predict a downlink beam with greater accuracy in examples in which an associated UE receive beam is included in the training information input to the machine learning model. For example, a UE rotation or a maximum permissible exposure event may gradually alter the UE receive beam, in which case the network entity transmit beam may also gradually be altered. However, other different wireless systems, including UEs, may not be configured to provide (for example, transmit) UE receive beam information to the network entity. Additionally, or alternatively, in some examples, fully disclosing aspects of the UE receive beam to the network entity may expose secret or secure information about the UE.

Various aspects generally relate to a UE providing UE receive beam information to a network entity, such that the network entity may train a machine learning model using the provided beam information, the machine learning model for generating a channel characteristic prediction at the UE. In some examples, the receive beam information (for example, an identifier of one or more reference signals for implicit receive beam information or a beamforming precoder, antenna panel identifiers, orientations of the antenna panel, angle of arrival, zenith of arrival, or any combination thereof for explicit receive beam information) is associated with a receive beam selected by the UE based on a beam sweeping procedure. In some examples, the UE provides the receive beam information to the network entity in conjunction with (for example, as part of or separate from but in addition to) a channel characteristics report associated with a set of channel measurement reports (for example, CSI reports). In some examples, the UE may report the UE receive beam information implicitly so that a UE implementation used to select the receive beam is not disclosed to the network entity. The UE may implicitly report the UE receive beam information based on transmitting multiple reference signals indicating the beam information, which may include information for one or more sets of channel measurement resources and a direction of reception for communications (for example, the beam direction). In some other examples, the UE may report the receive beam information explicitly, for instance, in examples in which disclosure of the UE implementation is acceptable. As such, the network entity may train the machine learning model using the implicit UE receive beam information, or the explicit UE receive beam information, or both.

In some examples, the network entity may then transmit signaling to the UE including an indication of the trained machine learning model that enables the UE to download or otherwise access the trained machine learning model from a server. In some cases, the UE may input a spatial or time domain down-sampled channel characteristic to the trained machine learning model. The trained machine learning model may output one or more predictions of channel characteristics (for example, a reference signal receive power (RSRP), a signal-to-interference-plus-noise ratio (SINR), a rank indicator (RI), a precoding matrix indicator (PMI), a layer indicators (LI), a channel quality indicator (CQI), or any combination thereof) of a set of channel measurement resources for uplink or downlink communications with the network entity. For example, the UE and the network entity may use the one or more channel characteristic predictions to select a beam, such as a receive beam or a transmit beam, for communicating with the network entitypredict an RSRP for communications with the network entity, and may use the prediction to select a beam that may, for example, maximize the RSRP.

Particular aspects of the subject matter described in this disclosure may be implemented to realize one or more of the following potential advantages. The techniques employed by the described UEs and the described network entities provide improved reliability and accuracy of a channel characteristic prediction based on training a machine learning model with UE receive beam information. Using a machine learning model that has been trained on UE receive beam information to obtain a more reliable and accurate channel characteristic prediction may improve beam sweeping procedures by reducing or eliminating inefficient downlink beam selection (for example, selecting a beam that is not associated with a greatest reference signal received power (RSRP)), which may also reduce the resources used for beam management between the UE and the network entity. In some implementations, operations performed by the described UE and the described network entity also support improvements to power consumption, reliability for uplink communication, spectral efficiency, higher data rates and, in some examples, low latency for uplink communication, among other benefits, based on better channel characteristic predictions that are, in turn, based on training the machine learning model using the receive beam information.

Aspects of the disclosure are initially described in the context of wireless communication systems. An additional wireless communication system and process flows are then provided to describe aspects of the disclosure. Aspects of the disclosure are further illustrated by and described with reference to apparatus diagrams, system diagrams, and flowcharts that relate to predictive resource management using UE information in a machine learning model.

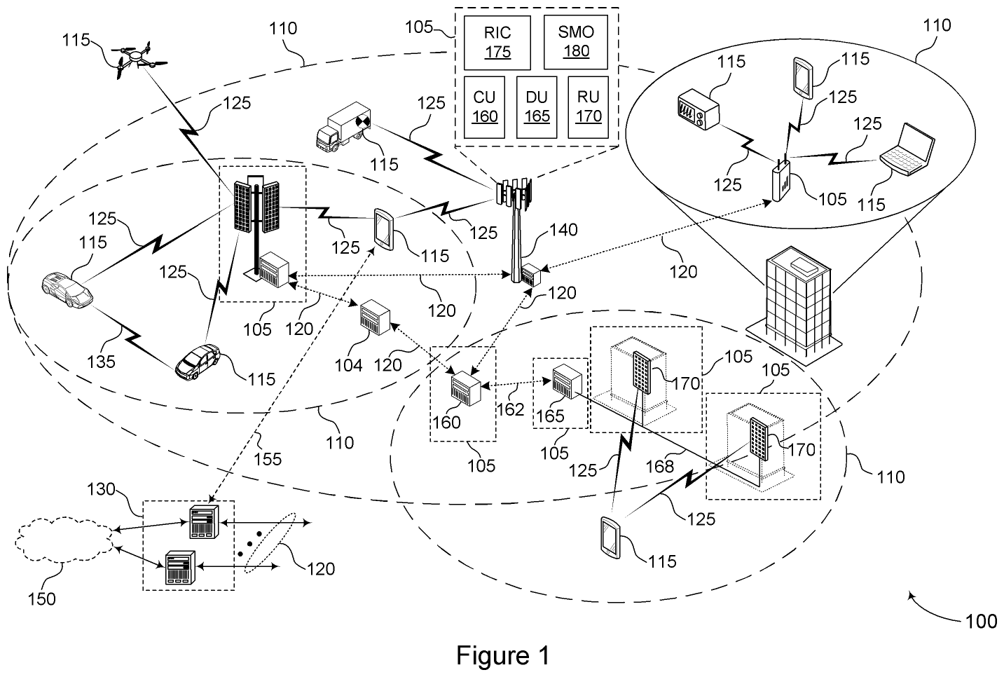

FIG. 1 illustrates an example of a wireless communication system 100 that supports predictive resource management using UE information in a machine learning model in accordance with one or more aspects of the present disclosure. The wireless communication system 100 may include one or more network entities 105, one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (for example, a radio frequency (RF) access link). For example, a network entity 105 may support a coverage area 110 (for example, a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

A node of the wireless communication system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or among other examples may include disclosure of the UE 115, network entity 105, apparatus, device, computing system, or among other examples being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (for example, in accordance with an S1, N2, N3, or other interface protocol). In some examples, network entities 105 may communicate with one another over a backhaul communication link 120 (for example, in accordance with an X2, Xn, or other interface protocol) either directly (for example, directly between network entities 105) or indirectly (for example, via a core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication links 120, midhaul communication links 162, or fronthaul communication links 168 may be or include one or more wired links (for example, an electrical link, an optical fiber link), one or more wireless links (for example, a radio link, a wireless optical link), among other examples or various combinations thereof. A UE 115 may communicate with the core network 130 through a communication link 155.

One or more of the network entities 105 described herein may include or may be referred to as a base station 140 (for example, a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within a single network entity 105 (for example, a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU) 160, a distributed unit (DU) 165, a radio unit (RU) 170, a RAN Intelligent Controller (RIC) 175 (for example, a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 175 is flexible and may support different functionalities depending upon which functions (for example, network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3 (L3), layer 2 (L2)) functionality and signaling (for example, Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or more RUs 170). In some cases, a functional split between a CU 160 and a DU 165, or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (for example, F1, F1-c, F1-u), and a DU 165 may be connected to one or more RUs 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities 105 that are in communication over such communication links.

In wireless communication systems (for example, wireless communication system 100), infrastructure and spectral resources for radio access may support wireless backhaul link capabilities to supplement wired backhaul connections, providing an IAB network architecture (for example, to a core network 130). In some cases, in an IAB network, one or more network entities 105 (for example, IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (for example, a donor base station 140). The one or more donor network entities 105 (for example, IAB donors) may be in communication with one or more additional network entities 105 (for example, IAB nodes 104) via supported access and backhaul links (for example, backhaul communication links 120). IAB nodes 104 may include an IAB mobile termination (LAB-MT) controlled (for example, scheduled) by DUs 165 of a coupled IAB donor. An IAB-MT may include an independent set of antennas for relay of communication with UEs 115, or may share the same antennas (for example, of an RU 170) of an IAB node 104 used for access via the DU 165 of the IAB node 104 (for example, referred to as virtual IAB-MT (vIAB-MT)). In some examples, the IAB nodes 104 may include DUs 165 that support communication links with additional entities (for example, IAB nodes 104, UEs 115) within the relay chain or configuration of the access network (for example, downstream). In such cases, one or more components of the disaggregated RAN architecture (for example, one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support predictive resource management using UE information in a machine learning model. For example, some operations described as being performed by a UE 115 or a network entity 105 (for example, a base station 140) may additionally, or alternatively, be performed by one or more components of the disaggregated RAN architecture (for example, IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, in which the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communication (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (for example, an access link) over one or more carriers. The term “carrier” may refer to a set of RF spectrum resources having a defined physical layer structure for supporting the communication links 125. For example, a carrier used for a communication link 125 may include a portion of a RF spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities 105).

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both) such that the more resource elements that a device receives and the higher the order of the modulation scheme, the higher the data rate may be for the device. A wireless communication resource may refer to a combination of an RF spectrum resource, a time resource, and a spatial resource (for example, a spatial layer, a beam), and the use of multiple spatial resources may increase the data rate or data integrity for communication with a UE 115.

The time intervals for the network entities 105 or the UEs 115 may be expressed in multiples of a basic time unit, which may, for example, refer to a sampling period of Tₛ=1/(Δfₘₐₓ·N_{f}) seconds in which Δfₘₐₓ may represent the maximum supported subcarrier spacing, and N_{f} may represent the maximum supported discrete Fourier transform (DFT) size. Time intervals of a communication resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communication systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communication system 100 and may be referred to as a transmission time interval (TTI). In some examples, the TTI duration (for example, a quantity of symbol periods in a TTI) may be variable. Additionally, or alternatively, the smallest scheduling unit of the wireless communication system 100 may be dynamically selected (for example, in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (for example, a base station 140, an RU 170) may be movable and may provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

The wireless communication system 100 may be configured to support ultra-reliable communication or low-latency communication, or various combinations thereof. For example, the wireless communication system 100 may be configured to support ultra-reliable low-latency communication (URLLC). The UEs 115 may be designed to support ultra-reliable, low-latency, or critical functions. Ultra-reliable communication may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (for example, in accordance with a peer-to-peer (P2P), D2D, or sidelink protocol). In some examples, one or more UEs 115 of a group that are performing D2D communication may be within the coverage area 110 of a network entity 105 (for example, a base station 140, an RU 170), which may support aspects of such D2D communication being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communication may support a one-to-many (1:M) system in which each UE 115 transmits to each of the other UEs 115 in the group. In some examples, a network entity 105 may facilitate the scheduling of resources for D2D communication. In some other examples, D2D communication may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communication, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communication with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A network entity 105 or a UE 115 may use beam sweeping techniques as part of beamforming operations. For example, a network entity 105 (for example, a base station 140, an RU 170) may use multiple antennas or antenna arrays (for example, antenna panels) to conduct beamforming operations for directional communication with a UE 115. Some signals (for example, synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (for example, by a transmitting device, such as a network entity 105, or by a receiving device, such as a UE 115) a beam direction for later transmission or reception by the network entity 105.

Some signals, such as data signals associated with a particular receiving device, may be transmitted by transmitting device (for example, a transmitting network entity 105, a transmitting UE 115) along a single beam direction (for example, a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (for example, by a network entity 105 or a UE 115) may be performed using multiple beam directions, and the device may use a combination of digital precoding or beamforming to generate a combined beam for transmission (for example, from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (for example, a cell-specific reference signal (CRS), a CSI-RS), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted along one or more directions by a network entity 105 (for example, a base station 140, an RU 170), a UE 115 may employ similar techniques for transmitting signals multiple times along different directions (for example, for identifying a beam direction for subsequent transmission or reception by the UE 115) or for transmitting a signal along a single direction (for example, for transmitting data to a receiving device).

A receiving device (for example, a UE 115) may perform reception operations in accordance with multiple receive configurations (for example, directional listening) when receiving various signals from a receiving device (for example, a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, when receiving a data signal). The single receive configuration may be aligned along a beam direction determined based on listening according to different receive configuration directions (for example, a beam direction determined to have a highest signal strength, highest signal-to-noise ratio (SNR), or otherwise acceptable signal quality based on listening according to multiple beam directions).

A machine learning model may improve a beam selection process performed between a network entity 105 and a UE 115 during beam management. For example, the machine learning model may enhance channel state information (CSI) feedback, which may result in improved accuracy and prediction. The machine learning model may also provide positioning accuracy enhancements in examples in which the network entity 105 experiences non-line-of-sight (NLoS) conditions, such as in examples in which a line-of-sight (LoS) between the network entity 105 and a UE is blocked by an object. However, other different wireless communication systems may not provide a diverse set of data for training the machine learning model, which may cause the machine learning model to provide an ineffective prediction.

The network entity 105 and the UE 115 may jointly determine a beam pair for efficient communication. The network entity 105 may perform a SSB beam sweeping procedure for a serving cell, which may be operating on a primary frequency. The UE 115 may then measure the received power for each beam of the beam sweep and report to the network entity 105 which beam may have a highest received power. The network entity 105 may refine a transmit beam by performing a CSI-RS beam sweep using more narrow beams than were used in the SSB beam sweep. Again, the UE 115 may measure a received power for each transmitted beam and report to the network entity 105 which of the narrow beams may have a highest received power. The network entity 105 may transmit a CSI-RS repeatedly to the UE 115, while the UE 115 performs a receive beam sweep to find a receive beam that may produce a highest received power in association with the transmit beam.

In some cases, a network entity 105 may employ a machine learning model to predict the transmit beam that may result in the highest received power at the UE 115. In some examples, the network entity 105 may train the machine learning model with historically measured channel characteristics of the transmit beam. However, the machine learning model prediction may be more accurate in examples in which the network entity 105 uses receive beam information from the UE 115 to train the machine learning model. For example, the UE 115 may rotate or experience a maximum permissible exposure event, which may cause the receive beam at the UE 115 to be altered gradually. The transmit beam at the network entity 105 may also be altered gradually for efficient communication between the UE 115 and network entity 105. As such, in order for the machine learning model to accurately predict an efficient transmit beam for the network entity 105, the network entity 105 may train the machine learning model with historically measure channel characteristics and receive beam information. For example, the network entity 105 may train the machine learning model with channel characteristic data that may be specific to a given scenario, but in order for the machine learning model to be useful, the network entity 105 may train the machine learning model with diverse training data to support performance of various tasks between the network entity and UE. However, in some examples, the UE 115 receive beam information may not be available at the network entity 105, which may limit the accuracy of the prediction made by the machine learning model. Additionally, or alternatively, fully disclosing the features of the receive beam may expose secret or secure information.

In accordance with techniques, methods, and apparatuses described herein, the UE 115 may enhance CSI-RS reports to transmit receive beam information and associated transmit beam channel characteristics back to the network entity 105. In some examples, the UE 115 may perform implicit reporting of the receive beam by using additional channel measurement resources or sounding reference signal (SRS) resources to associate with different receive beam options, such that the UE 115 may avoid disclosing antenna or beaming implementations or causing the network entity 105 to train the machine learning model too diversely. That is, the UE 115 may avoid restricting the machine learning model to one UE implementation, model, or device. Additionally, or alternatively, the UE 115 may explicitly report the receive beam quantities in examples in which disclosure of the UE 115 implementation is not secret or secure. In some examples, the network entity 105 may transmit the machine learning model to the UE 115 so that the UE 115 may also perform receive beam prediction.

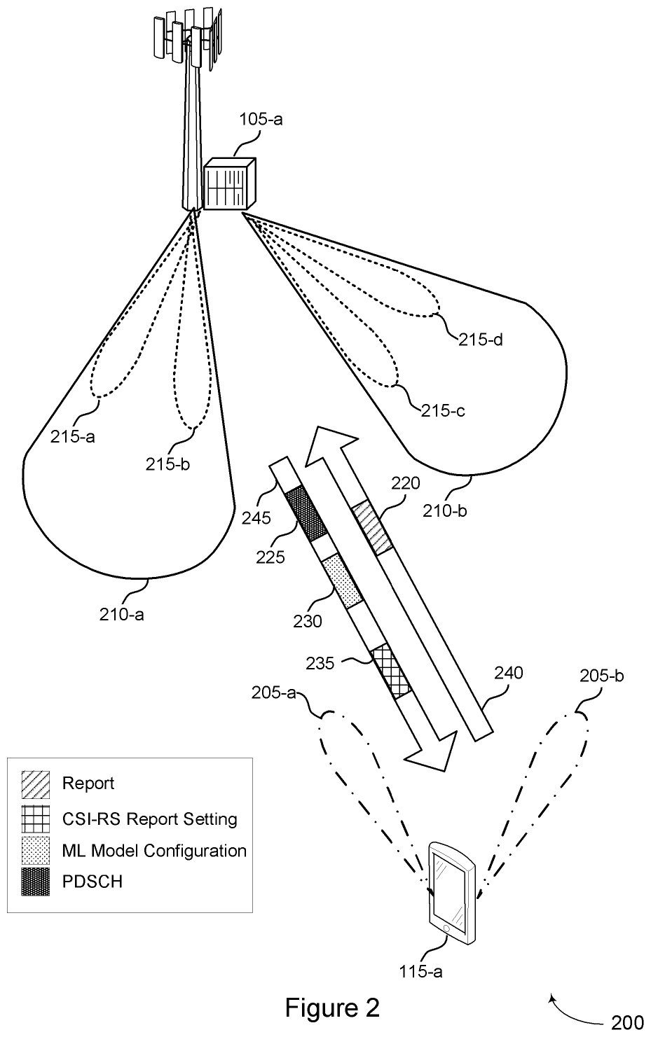

FIG. 2 illustrates an example of a wireless communication system 200 that supports predictive resource management using UE receive beam information in a machine learning model in accordance with one or more aspects of the present disclosure. The wireless communication system 200 may implement or be implemented to realize aspects of the wireless communication system 100. For example, the wireless communication system 200 illustrates communication between a UE 115-a and a network entity 105-a, which may be examples of corresponding devices described herein, including with reference to FIG. 1. In some cases, the UE 115-a may be in communication with the network entity 105-a. For example, the network entity 105-a may transmit control information, data, or both to the UE 115-a via a downlink communication link 245, while the UE 115-a may communicate control information, data or both with the network entity 105-a via an uplink communication link 240.

In some examples, to establish communication between the network entity 105-a and the UE 115-a, the network entity 105-a and the UE 115-a may perform one or more beam management (BM) procedures. For example, the network entity 105-a and the UE 115-a may perform beam sweeping procedures as described with reference to FIG. 1 during an initial access, beam measurement and determination procedures during a connected mode, beam reporting procedures during the connected mode (for example, L1 report for beam refinement), and beam recovery procedures for a beam failure recovery (BFR) or a radio link failure (RLF). In an initial access procedure, the network entity 105-a may transmit in multiple directions (for example, beams) to synchronize for communication with the UE 115-a. For example, the network entity 105-a may transmit a reference signal, such as an SSB, a CSI-RS, or both in a set of directions using supported beams (for example, may sweep through multiple SSB resources). In some examples, the network entity 105-a and UE 115-a may use wider beams for the initial access procedure, such as LI beams. The UE 115-a may receive one or more reference signals on the respective beams, and may select or report one or more preferred beams based on a signal metric. For example, the UE 115-a may send a report to the network entity 105-a indicating an SSB with a greatest RSRP value for a random access channel (RACH) procedure. The described procedure may also be performed by the network entity 105-a for selection of a transmission beam of the UE 115-a and for fine tuning of a receive beam at the network entity 105-a.

In some examples, there may be one or more different types of BM procedures, such as a first procedure type for downlink beams (P1), a second procedure type for downlink beams (P2), and a third procedure type for downlink beams (P3), a first procedure type for uplink beams (U1), a second procedure type for uplink beams (U2), and a third procedure type for uplink beams (U3).

In some examples, the network entity 105-a and the UE 115-a may use hierarchical beam refinement to select narrower beam pairs for communication (for example, using P1, P2, P3, or any combination thereof). For example, for P1, the network entity 105-a may sweep through multiple wider beams, and the UE 115-a may select a beam and report it to the network entity 105-a. For P2, the network entity 105-a may transmit in multiple relatively narrow directions (for example, may sweep through multiple narrower beams in a narrower range), in which the narrow directions may be based on the direction of the selected wide beam pair. The UE 115-a may receive a reference signal on the wide beams, and may report one of the narrow beams to use for transmissions, thus refining the transmission beam. For P3, the network entity 105-a may transmit the selected beam repeatedly (for example, may fix the beam), and the UE 115-a may refine a receive beam (for example, select a narrower receive beam) based on the transmitted beam. In some examples, P1, P2, and P3 processes may be used for downlink BM. In some examples, the network entity 105-a and the UE 115-a may employ uplink BM procedures for selecting a wide uplink beam pair, refining an uplink receive beam at the network entity 105-a, and refining an uplink transmit beam at the UE 115-a, which may be examples of U1, U2, and U3 processes, respectively. In some cases, the UE 115-a may report beams using a physical layer (for example, using L1 reporting). In some examples, the UE 115-a and the network entity 105-a may be in a connected mode with successful connection through selected beam pairs.

In some examples, the network entity 105-a and the UE 115-a may experience beam failure. For example, the UE 115-a may lose a connection with the network entity 105-a through the selected beam pairs. In some examples, the UE 115-a may perform BFR to select new suitable beam pairs through additional beam sweeping procedures. In some examples, the UE 115-a may be unable to find another suitable beam, and may experience RLF, resulting in a loss of connection with the network entity 105-a.

In some examples, beam sweeping procedures may exhibit inefficiencies in communication. For example, the network entity 105-a and the UE 115-a may perform excessive beam sweeping before selecting a suitable beam. Excessive beam sweeping may cause excessive latency, overhead, and power usage at the UE 115-a (for example, by altering phase shifting components for transmitting in new directions).

In some examples, the network entity 105-a and the UE 115-a may use machine learning based beam change prediction to mitigate drawbacks and improve beam sweeping procedures. For example, the network entity 105-a may implement a machine learning model to predict channel characteristics for communication. In some examples, the machine learning model may be an example of a deep learning machine learning model, in which a deep learning machine learning model may include multiple layers of operations between input and output. For example, the machine learning model may represent a convolution neural network (CNN) model, a recurrent neural network (RNN) model, a generative adversarial network (GAN) model, or any other deep learning or other neural network model. In some examples, the machine learning model may represent a subset of RNN models, such as an LSTM model, in which an LSTM model may involve learning and memorizing long-term dependencies over time to make predictions based on time series data. For example, the machine learning model may include an LSTM cell with a time-series input, and may transfer outputs from the LSTM cell into additional instances of the cell over time for selectively updating machine learning model values to make predictions. In some examples, the machine learning model may predict whether a preferred reference signal beam will remain preferred compared to a last received beam based on historical measurements. For example, the machine learning model may predict whether or not an SSB beam with a current highest RSRP will have the highest RSRP at a next measurement occasion.

In some examples, the network entity 105-a may train a machine learning model using a learning approach. For example, the network entity 105-a may train a machine learning model using supervised, semi-supervised, or unsupervised learning. Supervised learning may involve machine learning model training based on labeled training data, which may include example input-output pairs, whereas unsupervised learning may involve machine learning model training based on unlabeled training data, consisting of data without example input-output pairs. Semi-supervised learning may involve a small amount of labeled training data and a large amount of unlabeled training data. In some cases, the machine learning model may use supervised learning for prediction, as described herein.

A UE 115-a may support machine learning model training at a network entity 105-a by reporting receive beam information together with channel characteristics, in which the channel characteristics may include a L1 reference signal received power (L1-RSRP), a L1 signal-to-interference-noise ratio (L1-SINR), a rank indicator (RI), a channel quality indicator (CQI), a PMI, or any combination thereof. In some examples, the network entity 105-a may configure the UE 115-a with one or more reference signals (for example, by transmitting a CSI report setting 235). In some other cases, one or more parameters of the reference signals for a beam sweeping procedure may be otherwise defined (for example, preconfigured) at the UE 115-a. For example, during a SSB beam sweeping procedure, the network entity 105 may transmit using one or more wideband transmit beams, such as wideband transmit beam 210-a, wideband transmit beam 210-b, or both, which may have a first set of channel measurement resources. The UE 115-a may use reference signals to measure the received power of the corresponding wideband transmit beam 210-a and the wideband transmit beam 210-b. In some examples, the UE 115-a may determine that a receive beam 205-a has a higher received power than a receive beam 205-b. As such, the UE 115-a may transmit a report 220 over an uplink communication link 240, which may include channel characteristics of a set of channel measurement resources (for example, CSI-RS or SSB resources of the wideband transmit beam 210-a and the wideband transmit beam 210-b) and the information for receive beam 205-a.

In some examples, the network entity 105-a may also perform an additional CSI-RS beam sweep using one or more of a narrowband transmit beam 215-a, a narrowband transmit beam 215-b, a narrowband transmit beam 215-c, or a narrowband transmit beam 215-d, which may have a second set of channel measurement resources. For example, the UE 115-a may determine that both the receive beam 205-a and the receive beam 205-b have similar receive powers of a wideband transmit beam 210-a. In some examples, the UE 115-a may determine a highest received power of the second set of channel measurement resources (for example, the narrowband transmit beam 215-a through the narrowband transmit beam 215-d). In some examples, the UE 115-a may determine that there is a higher received power of the narrowband transmit beam 215-a than the narrowband transmit beam 215-b, and the receive beam 205-a may have a higher received power than the receive beam 205-b in association with narrowband transmit beam 215-a. As such, the UE 115-a may transmit a report 220 to the network entity 105-a indicating an identifier of the second set of channel measurement resources (for example, identifier for the narrowband transmit beam 215-a). In some cases, the UE 115-a may transmit the report 220 in uplink control information to the network entity 105-a. Additionally, or alternatively, the UE 115-a may transmit an identifier of the narrowband transmit beam 215-b. In some examples, the UE 115-a may transmit multiple identifiers of both the narrowband transmit beam 215-a and the narrowband transmit beam 215-b. In some examples, the identifier may be a channel measurement resource identifier and, in some other cases, the identifier may be a SRS identifier. In this way, the UE 115-a may determine the receive beam 205-a or the receive beam 205-b for measuring the first set of channel measurement resources based on the reported one or multiple channel measurement resources of the second set of channel measurement resources.

In some implementations, the UE 115-a may report receive beam information explicitly, such as by transmitting beamforming precoder information for a receive beam (for example, a transmit precoder matrix indicator (TPMI), phase or amplitude coefficients of respective radio frequency chains or phase shifters), antenna panel-identification of the receive beamforming precoder, orientation of the antenna panel of the receive beamforming, or angular information (for example, a target angle of arrival or a zenith of arrival). Transmitting such information may result in the UE 115-a disclosing its antenna and beamforming implementation. Additionally, or alternatively, explicitly disclosing the receive beam may restrict the machine learning model to the UE 115-a implementation and different UEs (for example, brands or models of UEs) may not be able to share the same machine learning model.

The UE 115-a may periodically send a report 220 to the network entity 105-a with updated implicit or explicit receive beam information for the receive beam 205-a, the receive beam 205-b, or both. The UE 115-a may transmit a capability message indicating a capability to support a type of receive beam information reporting. For example, a manufacturer may not want to expose the UE 115-a implementation to competitors, so the UE 115-a may report implicit beamforming information, such that even in examples in which the machine learning model may be used by other UEs, the implementation may remain secret. In some other examples, the UE 115-a may be unable to determine an orientation of the UE 115-a. The UE 115-a may send a report 220 to the network entity 105-a indicating that the UE 115-a may not support providing the orientation to the network entity 105-a. In some examples, it may be beneficial to disclose the UE 115-a beamforming parameters, such as detailed angular information, in order to avoid transmitting or measuring additional channel measurement resources.

In some examples, the network entity 105-a may train a machine learning model with spatial and time domain down-sampled channel characteristics of the first set of channel measurement resources and the receive beam information as received in the report 220. In some examples, the receive beam information may be related to the UE 115-a position or location information, which may also be included as input to the machine learning model. For example, at a location, a receive beam maximizing a CSI-RS resource L1-RSRP among the second set of CSI-RS resources may be determined as a receive beam fingerprint. A fingerprint may refer to properties of transmission such as location and configuration of signals such that another device may identify the UE 115-a from the receive beam.

The machine learning model may output a spatial and time domain channel characteristic prediction of at least the first set of channel measurement resources. Additionally, or alternatively, the machine learning model may output receive beamforming information (for example, based on the implicit or explicit report 220) of the predicted channel characteristics. The network entity 105-a may use the predicted receive beamforming information to transmit a physical downlink shared channel (PDSCH) 225 over a downlink communication link 245. In some examples, the machine model may be used for one or more time domain beam predictions, one or more spatial domain beam predictions, one or more frequency domain beam predictions, or a combination thereof. In some cases, the one or more time, spatial, or frequency domain beam predictions may include one or more channel characteristic predictions for different beams (for example, may include predictions for RSRPs, SINRs, RIS, PMIs, LIs, CQIs, or any combination thereof). In some examples, the one or more time domain predictions may include predicting future channel characteristics based on a history of channel measurements associated with the multiple reference signal resources. For example, the one or more time domain predictions may be based on a history of measurements, or based on measurements taken at the UE 115-a on one or more channel measurement resources, such as SSB or CSI-RS resources.

In some examples, the one or more spatial domain predictions may include predicting channel characteristics of non-measured reference signal resources (for example, SSB or CSI-RS resources) based on the measured multiple reference signal resources. In some cases, the one or more spatial domain predictions may include predicting an angle of departure for downlink precoding based on the measured multiple reference signal resources, or may include predicting a linear combination of the measured multiple reference signal resources as preferred downlink precoding.

In some examples, the network entity 105-a may transmit a machine learning model configuration 230 to the UE 115-a, other UEs, or both (for example, UEs that did not train the machine learning model). The UE 115-a may perform additional training on the machine learning model with spatial and time domain down sampled channel characteristics of the first set of channel measurement resources. Additionally, or alternatively, the UE 115-a may input implicit or explicit receive beam information to the machine learning model. The machine learning model may output a spatial and time domain channel characteristic prediction of at least the first set of channel measurement resources. Additionally, or alternatively, the machine learning model may output implicit or explicit receive beam information.

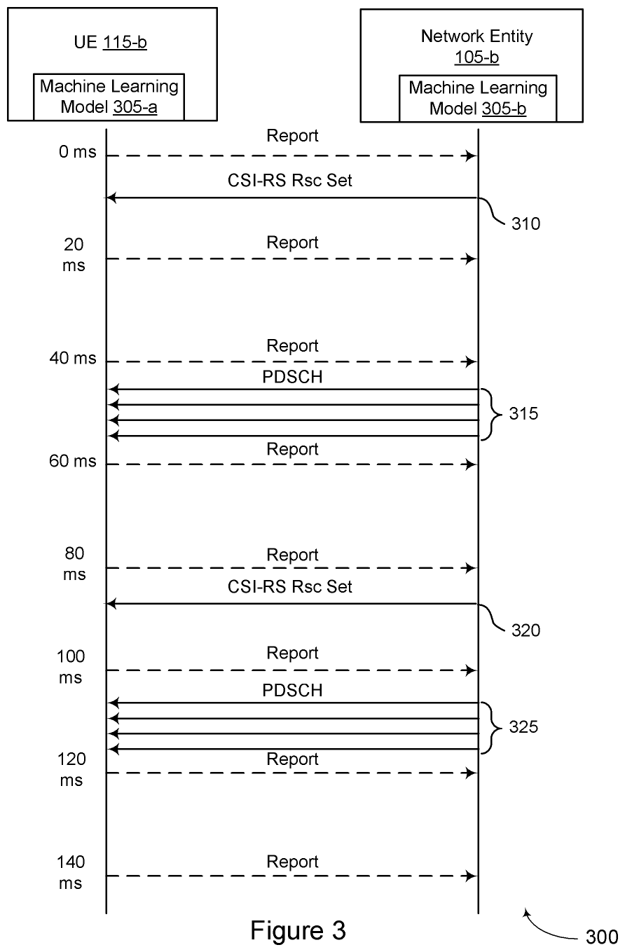

FIG. 3 illustrates an example of a process flow 300 that supports predictive resource management using UE receive beam information in a machine learning model in accordance with one or more aspects of the present disclosure. In some examples, the process flow 300 may implement aspects of wireless communication system 100 and wireless communication system 200. The process flow 300 may illustrate an example of a UE 115-b, which may implement a machine learning model 305-a, and a network entity 105-b, which may implement a machine learning model 305-b. The network entity 105-b and the UE 115-b may be examples of a network entity 105 and a UE 115 as described with reference to FIGS. 1 and 2. Alternative examples of the following may be implemented, in which some processes are performed in a different order than described or are not performed. In some cases, processes may include additional features not mentioned below, or further processes may be added.

In some implementations, the UE 115-b may communicate with the network entity 105-b. The network entity 105-b may train a machine learning model 305-b. In some examples, the UE 115-b may determine a receive beam of one or more channel measurement resources identifier based on comparing one or more first channel characteristics of a second set of channel measurement resources. For example, the network entity 105-b may configure the UE 115-b with one or more reference signals via a CSI report setting. In some examples, the network entity 105-b may transmit over a first and second set of channel measurement resources (for example, CSI-RS resources). The network entity 105-b may schedule PDSCH transmissions using the first set of CSI-RS resources. The UE 115-b may periodically transmit multiple reference signals of the first set of CSI-RS resources to help the network entity 105-b determine a proper transmit beam. For example, as shown in the process flow 300, the UE 115-b may transmit a report to the network entity 105-b every 20 ms. In some examples, the report may include a CSI-RS resource indicator (cri) RSRP. In some examples, the receive beam information may be reported in a carrier of the second part of a two part CSI report due to lower priority. For example, CSI reports including receive beam information may be of a lower priority than other CSI reports because machine learning model training may be a low priority task.

The network entity 105-b may further configure one or more second sets of CSI-RS resources, such that each of the second sets of CSI-RS resources may be overlap a CSI-RS resource within the first set of CSI-RS resources. In some examples, the angular spread of one CSI-RS resource within the second set of CSI-RS resources may be smaller than within the first set of CSI-RS resources. The UE 115-b may determine a receive beam, such that the reference signal received power may be maximized for a CSI-RS resource among the CSI-RS resources within the second set of CSI-RS resources. For example, the UE 115-b may identify a CSI-RS resource within the first set of CSI-RS resources. The UE 115-b may further identify a CSI-RS resource of the second set of CSI-RS resources that overlaps with the first set of CSI-RS resources. As such, the UE 115-b may determine the receive beam for the first set of CSI-RS resources based on the reported one or multiple channel measurement resources of the second set of channel measurement resources. In some examples, the UE 115-b may report the CSI-RS resource identifier of the receive beam (for example, CSI-RS resource identifier within the second set of CSI-RS resources) as the receive beam information. The identifier may be included with the cri-RSRP of the first set of CSI-RS resources that is reported every 20 ms in the process flow 300.

In some examples, the network entity 105-b may train a machine learning model 305-b using spatial and time domain down-sampled channel characteristics of the first set of channel measurement resources. The network entity 105-b may train the machine learning model 305-b with additional data, such as the periodically received report from the UE 115-b including the channel measurement resource identifiers within the second set of channel measurement resources of the receive beam information. For example, at every 80 ms in the process flow 300, the network entity 105-b may input the UE 115-b report data to the trained machine learning model 305-b.

The machine learning model 305-b may periodically output a spatial and time domain channel characteristic prediction of at least the first set of channel measurement resources. In some examples, the machine learning model 305-b may also output a cri-RSRP of the first set of CSI-RS resources and a CSI-RS resource identifier of the second set of channel measurement resources of the predicted channel characteristics (for example, predicting the UE receive beam information). For example, the machine learning model 305-b may output a prediction at every 20 ms interval before the next available 80 ms input sample arrives. In some examples, the predicted receive beam info may be used as labels for calculating the loss functions (for example, maximum permissible exposure or cross-entropy) in training the machine learning model 305-b. For example, at times 0 ms, 20 ms, and 40 ms in process flow 300, the UE 115-b may send a report, which may not be input directly into the machine learning model 305-b but may be used in the calculation of the loss function.

In another implementation, the network entity 105-b may send a configuration of the machine learning model 305-a to the UE 115-b prior to time 0 ms in the process flow 300 such that both the network entity 105-b and the UE 115-b may have access to a machine learning model 305-a or a machine learning model 305-b. The network entity machine learning model inference may be facilitated in the same manner as discussed previously (for example, extended reporting cycle for time domain prediction or less spatially measured beams for spatial domain prediction). The UE 115-b may use and train the machine learning model 305-a periodically with additional inputs. For example, every 80 ms of process flow 300 the UE 115-b may input the spatial and time domain down sampled channel characteristics of the first set of channel measurement resources (for example, cri-RSRP of the first set of CSI-RS resources) and the channel measurement resource identifier (for example, CSI-RS resource identifier) of the second set of CSI-RS resources to the machine learning model 305-a. The input may be determined based on the CSI-RS resource set transmitted by the network entity 105-b at 310 and 320. The machine learning model 305-a may output a predicted receive beam (for example, cri-RSRP of the first set of CSI-RS resources and a CSI-RS resource identifier of the second set of CSI-RS resources) periodically at each 20 ms before the next available 80 ms input sample. The UE 115-b may periodically report the spatial and time domain predicted cri-RSRP to the network entity 105-b. In some examples, the UE 115-b may use the machine learning model 305-a to obtain a channel characteristic prediction based on multiple reference signals transmitted in the report to the network entity 105-b every 20 ms.

At 315 and 325, the network entity 105-b may transmit multiple PDSCH messages using the transmit beam predicted by the machine learning model 305-b. The UE 115-b may receive the transmissions using a receive beam, which was reported to the network entity 105-b. In some examples, the UE 115-b may use a receive beam predicted by the machine learning model 305-a to receive the PDSCH messages.

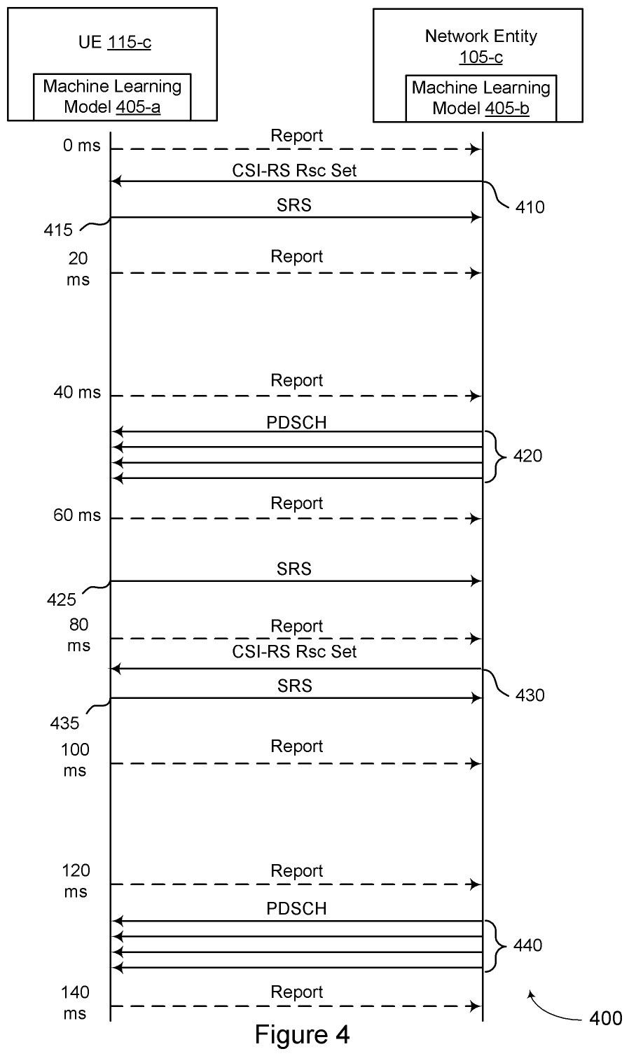

FIG. 4 illustrates an example of a process flow 400 that supports predictive resource management using UE receive beam information in a machine learning model in accordance with one or more aspects of the present disclosure. In some examples, the process flow 400 may implement aspects of wireless communication system 100, wireless communication system 200, and the process flow 300. The process flow 400 may illustrate an example of a UE 115-c, which may implement a machine learning model 405-a, and a network entity 105-c, which may implement a machine learning model 405-b. The network entity 105-c and the UE 115-c may be examples of a network entity 105 and a UE 115 as described with reference to FIGS. 1 and 2. Alternative examples of the following may be implemented, in which some processes are performed in a different order than described or are not performed. In some cases, processes may include additional features not mentioned below, or further processes may be added.

FIG. 4 shows a process for implicit reporting of a receive beam based on SRS and other channel measurement resources. For example, the UE 115-c may report one or more SRS resource identifiers of a SRS resource set of a CSI report setting. In some examples, the transmit spatial filters for the SRS resources may be within the SRS resource set that is determined by the channel measurement resources within a second set of channel measurement resources that are also configured by the first CSI report setting. As such, the UE 115-c may determine a receive beam for measuring the first set of channel measurement resources based on the transmit filters of the reported SRS resource identifier. The UE 115-c may send the report as an SRS resource indicator (SRI) periodically to the network entity 105-c. In some examples, the report may be sent every 20 ms as shown in the process flow 400.

In some implementations, the network entity 105-c may train a machine learning model 405-b with input received from the UE 115-c in the periodic reports. For example, the network entity 105-c may input the associated SRS resource identifier of the UE receive beam. Additionally, or alternatively, the network entity 105-c may input spatial and time domain down sampled channel characteristics of the first set of channel measurement resources. At 415, 425, and 435, the UE 115-c may periodically transmit an SRS resource identifier of the determined receive beam to the network entity 105-c. The network entity 105-c may use the identifier to further train the machine learning model 405-b.

The machine learning model 405-b may periodically provide an output including a spatial and time domain channel characteristic prediction of at least the first set of channel measurement resources. Additionally, or alternatively, the machine learning model 405-b may output a predicted UE receive beam (for example, SRS resource identifier within the SRS resource set of the predicted channel characteristics of the first set of channel measurement resources). In the example shown in the process flow 400, the machine learning model 405-b may provide output data every 80 ms.

In another implementation, the network entity 105-c may transmit a machine learning model configuration to the UE 115-c prior to the time 0 ms shown in process flow 400. As such, the UE 115-c may use the machine learning model 405-a to predict spatial and time domain channel characteristics of the first set of channel measurement resources. For example, at 410 and 430 the network entity 105-c may periodically transmit a CSI-RS resource set to the UE 115-c. The UE 115-c may determine a receive beam based on the received CSI-RS resource set. As such, the UE 115-c may input the spatial and time domain down-sampled channel characteristics of the first set of channel measurement resources and the determined receive beam information (for example, SRS resource identifier or the associated channel measurement resource identifier within the second set of channel measurement resources of the determined receive beam) to the machine learning model 405-a.

In some examples, the transmit spatial filters for the SRS resources within the SRS resource set may be determined by the channel measurement resources within the second set of channel measurement resources. As such, the UE receive beam from measuring the first set of channel measurement resources may be determined based on the transmit filters of the reported SRS resources.

The machine learning model 405-a may output a spatial and time domain channel characteristic prediction of at least the first set of channel measurement resources. Additionally, or alternatively, the machine learning model 405-a may output the UE predicted receive beam (for example, SRS resource identifier within the SRS resource set or CSI-RS resource identifier within the second set of channel measurement resources of the predicted channel characteristics).

At 420 and 440, the network entity 105-c may periodically transmit PRSCH messages using the transmit beam predicted by the machine learning model 405-b. The UE 115-c may receive the transmissions using a receive beam that helped train the machine learning model 405-b. In some examples, the UE 115-c may use a receive beam predicted by the machine learning model 405-a.

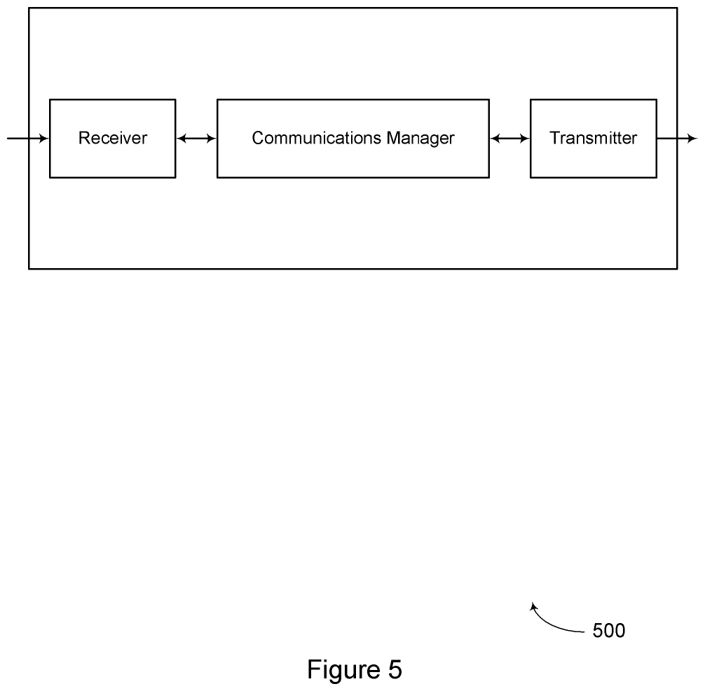

FIG. 5 shows a device that supports predictive resource management using user equipment information in a machine learning model in accordance with one or more aspects of the present disclosure. The device may be an example of aspects of a UE 115 as described herein. The device may include a receiver, a transmitter, and a communications manager. The communications manager can be implemented, at least in part, by one or both of a modem and a processor. Each of these components may be in communication with one another (e.g., via one or more buses).

The receiver may provide a means for receiving information such as packets, user data, control information, or any combination thereof associated with various information channels (e.g., control channels, data channels, information channels related to predictive resource management using user equipment information in a machine learning model). Information may be passed on to other components of the device. The receiver may utilize a single antenna or a set of multiple antennas.

The transmitter may provide a means for transmitting signals generated by other components of the device. For example, the transmitter may transmit information such as packets, user data, control information, or any combination thereof associated with various information channels (e.g., control channels, data channels, information channels related to predictive resource management using user equipment information in a machine learning model). In some examples, the transmitter may be co-located with a receiver in a transceiver module. The transmitter may utilize a single antenna or a set of multiple antennas.

The communications manager, the receiver, the transmitter, or various combinations thereof or various components thereof may be examples of means for performing various aspects of predictive resource management using user equipment information in a machine learning model as described herein. For example, the communications manager, the receiver, the transmitter, or various combinations or components thereof may support a method for performing one or more of the functions described herein.

In some examples, the communications manager, the receiver, the transmitter, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager, the receiver, the transmitter, or various combinations or components thereof may be implemented in code (e.g., as communications management software or firmware) executed by a processor. If implemented in code executed by a processor, the functions of the communications manager, the receiver, the transmitter, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager may be configured to perform various operations (e.g., receiving, obtaining, monitoring, outputting, transmitting) using or otherwise in cooperation with the receiver, the transmitter, or both. For example, the communications manager may receive information from the receiver, send information to the transmitter, or be integrated in combination with the receiver, the transmitter, or both to obtain information, output information, or perform various other operations as described herein.

The communications manager may support wireless communication at a UE in accordance with examples as disclosed herein. For example, the communications manager may be configured as or otherwise support a means for transmitting a set of multiple reference signals indicating information associated with a first set of channel measurement resources, a second set of channel measurement resources, and a direction of reception for communications, the information corresponding to a receive beam at the UE corresponding to the direction of reception for the communications. The communications manager may be configured as or otherwise support a means for receiving, based on transmitting the set of multiple reference signals, signaling indicating a machine learning model for obtaining a channel characteristic prediction associated with the first set of channel measurement resources, the machine learning model based on the receive beam at the UE. The communications manager may be configured as or otherwise support a means for inputting, to the machine learning model, an input to obtaining the channel characteristic prediction. The communications manager may be configured as or otherwise support a means for receiving signaling based on obtaining the channel characteristic prediction associated with the first set of channel measurement resources.

Additionally, or alternatively, the communications manager may support wireless communication at a UE in accordance with examples as disclosed herein. For example, the communications manager may be configured as or otherwise support a means for transmitting information associated with one or more channel measurement resources and a direction of reception for communications. The communications manager may be configured as or otherwise support a means for receiving signaling indicating a machine learning model for obtaining a channel characteristic prediction associated with the one or more channel measurement resources based on transmitting the information. The communications manager may be configured as or otherwise support a means for inputting, to the machine learning model, an input to obtaining the channel characteristic prediction associated with the one or more channel measurement resources. The communications manager may be configured as or otherwise support a means for receiving signaling based on obtaining the channel characteristic prediction associated with the one or more channel measurement resources.

By including or configuring the communications manager in accordance with examples as described herein, the device (e.g., a processor controlling or otherwise coupled with the receiver, the transmitter, the communications manager, or a combination thereof) may support techniques for more efficient utilization of communication resources.

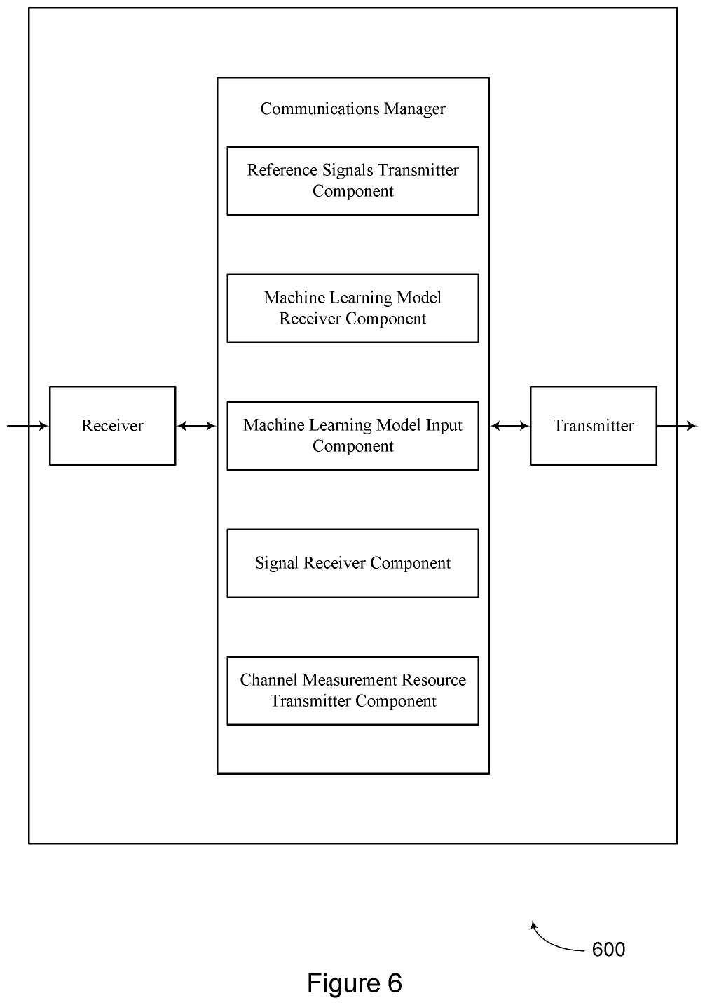

FIG. 6 shows a device that supports predictive resource management using user equipment information in a machine learning model in accordance with one or more aspects of the present disclosure. The device may be an example of aspects of a device or a UE 115 as described herein. The device may include a receiver, a transmitter, and a communications manager. The communications manager can be implemented, at least in part, by one or both of a modem and a processor. Each of these components may be in communication with one another (e.g., via one or more buses).

The receiver may provide a means for receiving information such as packets, user data, control information, or any combination thereof associated with various information channels (e.g., control channels, data channels, information channels related to predictive resource management using user equipment information in a machine learning model). Information may be passed on to other components of the device. The receiver may utilize a single antenna or a set of multiple antennas.

The transmitter may provide a means for transmitting signals generated by other components of the device. For example, the transmitter may transmit information such as packets, user data, control information, or any combination thereof associated with various information channels (e.g., control channels, data channels, information channels related to predictive resource management using user equipment information in a machine learning model). In some examples, the transmitter may be co-located with a receiver in a transceiver module. The transmitter may utilize a single antenna or a set of multiple antennas.

The device, or various components thereof, may be an example of means for performing various aspects of predictive resource management using user equipment information in a machine learning model as described herein. For example, the communications manager may include a reference signals transmitter component, a machine learning model receiver component, a machine learning model input component, a signal receiver component, a channel measurement resource transmitter component, or any combination thereof. The communications manager may be an example of aspects of a communications manager as described herein. In some examples, the communications manager, or various components thereof, may be configured to perform various operations (e.g., receiving, obtaining, monitoring, outputting, transmitting) using or otherwise in cooperation with the receiver, the transmitter, or both. For example, the communications manager may receive information from the receiver, send information to the transmitter, or be integrated in combination with the receiver, the transmitter, or both to obtain information, output information, or perform various other operations as described herein.

The communications manager may support wireless communication at a UE in accordance with examples as disclosed herein. The reference signals transmitter component may be configured as or otherwise support a means for transmitting a set of multiple reference signals indicating information associated with a first set of channel measurement resources, a second set of channel measurement resources, and a direction of reception for communications, the information corresponding to a receive beam at the UE corresponding to the direction of reception for the communications. The machine learning model receiver component may be configured as or otherwise support a means for receiving, based on transmitting the set of multiple reference signals, signaling indicating a machine learning model for obtaining a channel characteristic prediction associated with the first set of channel measurement resources, the machine learning model based on the receive beam at the UE. The machine learning model input component may be configured as or otherwise support a means for inputting, to the machine learning model, an input to obtain the channel characteristic prediction. The signal receiver component may be configured as or otherwise support a means for receiving signaling based on obtaining the channel characteristic prediction associated with the first set of channel measurement resources.

Additionally, or alternatively, the communications manager may support wireless communication at a UE in accordance with examples as disclosed herein. The channel measurement resource transmitter component may be configured as or otherwise support a means for transmitting information associated with one or more channel measurement resources and a direction of reception for communications. The machine learning model receiver component may be configured as or otherwise support a means for receiving signaling indicating a machine learning model for obtaining a channel characteristic prediction associated with the one or more channel measurement resources based on transmitting the information. The machine learning model input component may be configured as or otherwise support a means for inputting, to the machine learning model, an input to obtain the channel characteristic prediction associated with the one or more channel measurement resources. The signal receiver component may be configured as or otherwise support a means for receiving signaling based on obtaining the channel characteristic prediction associated with the one or more channel measurement resources.

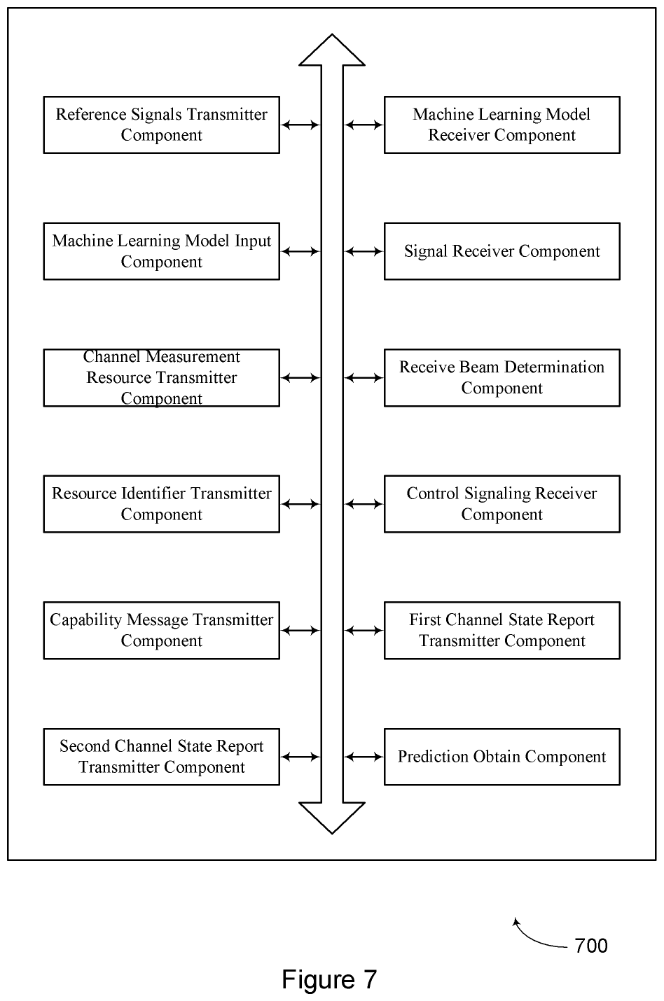

FIG. 7 shows a communications manager that supports predictive resource management using user equipment information in a machine learning model in accordance with one or more aspects of the present disclosure. The communications manager may be an example of aspects of a communications manager, a communications manager, or both, as described herein. The communications manager, or various components thereof, may be an example of means for performing various aspects of predictive resource management using user equipment information in a machine learning model as described herein. For example, the communications manager may include a reference signals transmitter component, a machine learning model receiver component, a machine learning model input component, a signal receiver component, a channel measurement resource transmitter component, a receive beam determination component, a resource identifier transmitter component, a control signaling receiver component, a capability message transmitter component, a first channel state report transmitter component, a second channel state report transmitter component, a prediction obtain component, or any combination thereof. Each of these components may communicate, directly or indirectly, with one another (e.g., via one or more buses).

The communications manager may support wireless communication at a UE in accordance with examples as disclosed herein. The reference signals transmitter component may be configured as or otherwise support a means for transmitting a set of multiple reference signals indicating information associated with a first set of channel measurement resources, a second set of channel measurement resources, and a direction of reception for communications, the information corresponding to a receive beam at the UE corresponding to the direction of reception for the communications. The machine learning model receiver component may be configured as or otherwise support a means for receiving, based on transmitting the set of multiple reference signals, signaling indicating a machine learning model for obtaining a channel characteristic prediction associated with the first set of channel measurement resources, the machine learning model based on the receive beam at the UE. The machine learning model input component may be configured as or otherwise support a means for inputting, to the machine learning model, an input to obtain the channel characteristic prediction. The signal receiver component may be configured as or otherwise support a means for receiving signaling based on obtaining the channel characteristic prediction associated with the first set of channel measurement resources.

In some examples, the receive beam determination component may be configured as or otherwise support a means for determining the receive beam for the UE corresponding to the direction of reception for the communications based on one or more channel measurement resource identifiers corresponding to the second set of channel measurement resources and one or more first channel characteristics associated with the second set of channel measurement resources, where the information includes the one or more first channel characteristics. In some examples, the resource identifier transmitter component may be configured as or otherwise support a means for transmitting the one or more channel measurement resource identifiers in a same signal as a subset of the set of multiple reference signals associated with the second set of channel measurement resources, where the receiving the signaling is based on transmitting the one or more channel measurement resource identifiers.

In some examples, the machine learning model input component may be configured as or otherwise support a means for inputting, to the machine learning model based on transmitting the set of multiple reference signals, the one or more channel measurement resource identifiers, one or more second channel characteristics associated with the first set of channel measurement resources, or both. In some examples, the prediction obtain component may be configured as or otherwise support a means for obtaining the channel characteristic prediction associated with the first set of channel measurement resources based on inputting the one or more channel measurement resource identifiers, the one or more second channel characteristics associated with the first set of channel measurement resources, or both.

In some examples, the reference signals transmitter component may be configured as or otherwise support a means for transmitting, in the same signal as the subset of the set of multiple reference signals, an indication of a reference signal receive power associated with the first set of channel measurement resources.

In some examples, the one or more first channel characteristics include one or more reference signal receive power values for the subset of the set of multiple reference signals.

In some examples, the receive beam determination component may be configured as or otherwise support a means for determining a spatial filter corresponding to the receive beam based on one or more sounding reference signal resource identifiers corresponding to the second set of channel measurement resources, where the one or more channel measurement resource identifiers include the one or more sounding reference signal resource identifiers.

In some examples, the control signaling receiver component may be configured as or otherwise support a means for receiving control signaling indicating to the UE to transmit, with the set of multiple reference signals, a set of multiple channel characteristics associated with the first set of channel measurement resources. In some examples, the reference signals transmitter component may be configured as or otherwise support a means for transmitting the set of multiple channel characteristics in a same signal as the set of multiple reference signals, the set of multiple channel characteristics including one or more of a reference signal receive power, a signal interference-to-noise ratio, a rank indicator, a channel quality indicator, or a precoding matrix indicator.

In some examples, the capability message transmitter component may be configured as or otherwise support a means for transmitting a message indicating a capability of the UE to support reporting the information associated with the first set of channel measurement resources, the second set of channel measurement resources, or the direction of reception for the communications, where transmitting the set of multiple reference signals indicating the information is based on the capability.

In some examples, the reference signals transmitter component may be configured as or otherwise support a means for transmitting the set of multiple reference signals according to a periodicity. In some examples, the signal receiver component may be configured as or otherwise support a means for receiving, according to the periodicity, additional signaling indicating an update to the machine learning model based on transmitting the set of multiple reference signals.

In some examples, the first channel state report transmitter component may be configured as or otherwise support a means for transmitting a first channel state information report of a first priority. In some examples, the second channel state report transmitter component may be configured as or otherwise support a means for transmitting a second channel state information report of a second priority, the second channel state information report including the information, where the first priority is greater than the second priority.

In some examples, a first angular spread of a first reference signal of the set of multiple reference signals associated with the second set of channel measurement resources is smaller than a second angular spread of a second reference signal of the set of multiple reference signals associated with the first set of channel measurement resources.

In some examples, the set of multiple reference signals include a channel state information-reference signal, a synchronization signal block, or both.

In some examples, the channel characteristic prediction associated with the first set of channel measurement resources is for a time domain channel characteristic of the set of multiple reference signals, a spatial domain channel characteristic of the set of multiple reference signals, or both.

Additionally, or alternatively, the communications manager may support wireless communication at a UE in accordance with examples as disclosed herein. The channel measurement resource transmitter component may be configured as or otherwise support a means for transmitting information associated with one or more channel measurement resources and a direction of reception for communications. In some examples, the machine learning model receiver component may be configured as or otherwise support a means for receiving signaling indicating a machine learning model for obtaining a channel characteristic prediction associated with the one or more channel measurement resources based on transmitting the information. In some examples, the machine learning model input component may be configured as or otherwise support a means for inputting, to the machine learning model, an input to obtain the channel characteristic prediction associated with the one or more channel measurement resources. In some examples, the signal receiver component may be configured as or otherwise support a means for receiving signaling based on obtaining the channel characteristic prediction associated with the one or more channel measurement resources.

In some examples, the machine learning model input component may be configured as or otherwise support a means for inputting, to the machine learning model, one or more channel characteristics associated with the one or more channel measurement resources, the transmitted information, or both. In some examples, the prediction obtain component may be configured as or otherwise support a means for obtaining the channel characteristic prediction associated with the one or more channel measurement resources, the transmitted information, or both based on the inputting.

In some examples, the capability message transmitter component may be configured as or otherwise support a means for transmitting a message indicating a capability of the UE to support transmitting the information, where transmitting the information is based on the capability.

In some examples, the channel measurement resource transmitter component may be configured as or otherwise support a means for transmitting the information according to a periodicity. In some examples, the signal receiver component may be configured as or otherwise support a means for receiving, according to the periodicity, additional signaling indicating an update to the machine learning model based on transmitting the information.

In some examples, the first channel state report transmitter component may be configured as or otherwise support a means for transmitting a first channel state information report of a first priority. In some examples, the second channel state report transmitter component may be configured as or otherwise support a means for transmitting a second channel state information report of a second priority, the second channel state information report including the information, where the first priority is greater than the second priority.

In some examples, the information includes a phase coefficient associated with a radio-frequency chain, an amplitude coefficient associated with the radio-frequency chain, a phase coefficient associated with a phase shifter, an amplitude associated with the phase shifter, an antenna panel identifier associated with the direction of reception, an orientation of an antenna panel associated with the direction of reception, a target angle of arrival for the communications, or a zenith of arrival for the communications.

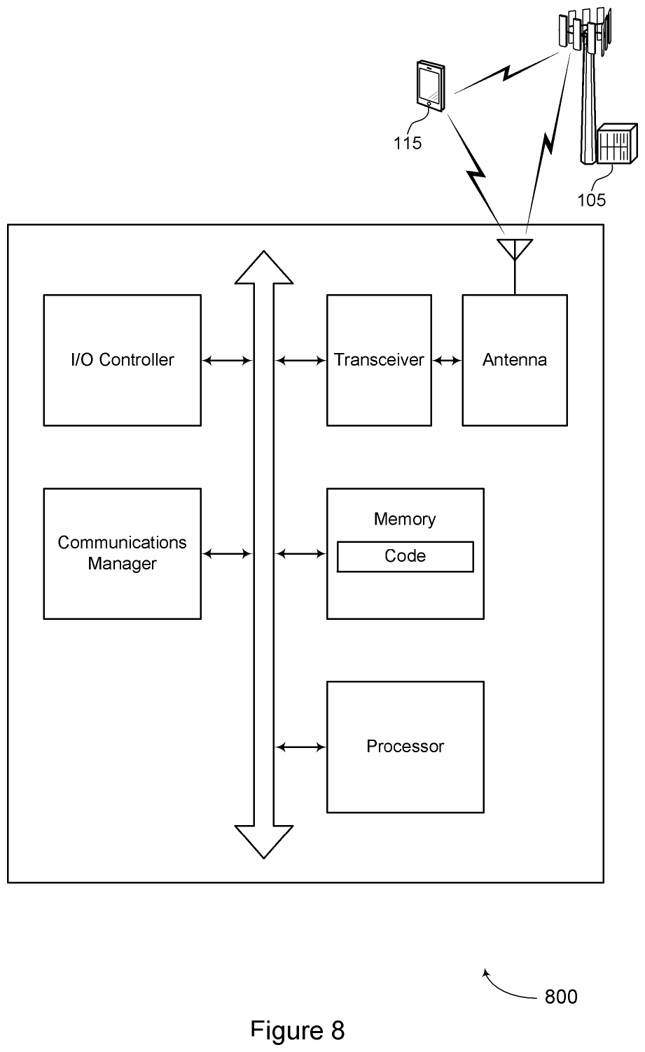

FIG. 8 shows a system 800 including a device that supports predictive resource management using user equipment information in a machine learning model in accordance with one or more aspects of the present disclosure. The device may be an example of or include the components of a device, a device, or a UE 115 as described herein. The device may communicate (e.g., wirelessly) with one or more network entities 105, one or more UEs 115, or any combination thereof. The device may include components for bi-directional voice and data communications including components for transmitting and receiving communications, such as a communications manager, an input/output (I/O) controller, a transceiver, an antenna, a memory, code, and a processor. These components may be in electronic communication or otherwise coupled (e.g., operatively, communicatively, functionally, electronically, electrically) via one or more buses (e.g., a bus).

The I/O controller may manage input and output signals for the device. The I/O controller may also manage peripherals not integrated into the device. In some cases, the I/O controller may represent a physical connection or port to an external peripheral. In some cases, the I/O controller may utilize an operating system such as iOS®, ANDROID®, MS-DOS®, MS-WINDOWS®, OS/2®, UNIX®, LINUX®, or another known operating system. Additionally or alternatively, the I/O controller may represent or interact with a modem, a keyboard, a mouse, a touchscreen, or a similar device. In some cases, the I/O controller may be implemented as part of a processor, such as the processor. In some cases, a user may interact with the device via the I/O controller or via hardware components controlled by the I/O controller.

In some cases, the device may include a single antenna. However, in some other cases, the device may have more than one antenna, which may be capable of concurrently transmitting or receiving multiple wireless transmissions. The transceiver may communicate bi-directionally, via the one or more antennas, wired, or wireless links as described herein. For example, the transceiver may represent a wireless transceiver and may communicate bi-directionally with another wireless transceiver. The transceiver may also include a modem to modulate the packets, to provide the modulated packets to one or more antennas for transmission, and to demodulate packets received from the one or more antennas. The transceiver, or the transceiver and one or more antennas, may be an example of a transmitter, a transmitter, a receiver, a receiver, or any combination thereof or component thereof, as described herein.

The memory may include random access memory (RAM) and read-only memory (ROM). The memory may store computer-readable, computer-executable code including instructions that, when executed by the processor, cause the device to perform various functions described herein. The code may be stored in a non-transitory computer-readable medium such as system memory or another type of memory. In some cases, the code may not be directly executable by the processor but may cause a computer (e.g., when compiled and executed) to perform functions described herein. In some cases, the memory may contain, among other things, a basic I/O system (BIOS) which may control basic hardware or software operation such as the interaction with peripheral components or devices.

The processor may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor may be configured to operate a memory array using a memory controller. In some other cases, a memory controller may be integrated into the processor. The processor may be configured to execute computer-readable instructions stored in a memory (e.g., the memory) to cause the device to perform various functions (e.g., functions or tasks supporting predictive resource management using user equipment information in a machine learning model). For example, the device or a component of the device may include a processor and memory coupled with or to the processor, the processor and memory configured to perform various functions described herein.

The communications manager may support wireless communication at a UE in accordance with examples as disclosed herein. For example, the communications manager may be configured as or otherwise support a means for transmitting a set of multiple reference signals indicating information associated with a first set of channel measurement resources, a second set of channel measurement resources, and a direction of reception for communications, the information corresponding to a receive beam at the UE corresponding to the direction of reception for the communications. The communications manager may be configured as or otherwise support a means for receiving, based on transmitting the set of multiple reference signals, signaling indicating a machine learning model for obtaining a channel characteristic prediction associated with the first set of channel measurement resources, the machine learning model based on the receive beam at the UE. The communications manager may be configured as or otherwise support a means for inputting, to the machine learning model, an input to obtaining the channel characteristic prediction. The communications manager may be configured as or otherwise support a means for receiving signaling based on obtaining the channel characteristic prediction associated with the first set of channel measurement resources.

Additionally, or alternatively, the communications manager may support wireless communication at a UE in accordance with examples as disclosed herein. For example, the communications manager may be configured as or otherwise support a means for transmitting information associated with one or more channel measurement resources and a direction of reception for communications. The communications manager may be configured as or otherwise support a means for receiving signaling indicating a machine learning model for obtaining a channel characteristic prediction associated with the one or more channel measurement resources based on transmitting the information. The communications manager may be configured as or otherwise support a means for inputting, to the machine learning model, an input to obtaining the channel characteristic prediction associated with the one or more channel measurement resources. The communications manager may be configured as or otherwise support a means for receiving signaling based on obtaining the channel characteristic prediction associated with the one or more channel measurement resources.

By including or configuring the communications manager in accordance with examples as described herein, the device may support techniques for improved communication reliability, more efficient utilization of communication resources, and improved coordination between devices.

In some examples, the communications manager may be configured to perform various operations (e.g., receiving, monitoring, transmitting) using or otherwise in cooperation with the transceiver, the one or more antennas, or any combination thereof. Although the communications manager is illustrated as a separate component, in some examples, one or more functions described with reference to the communications manager may be supported by or performed by the processor, the memory, the code, or any combination thereof. For example, the code may include instructions executable by the processor to cause the device to perform various aspects of predictive resource management using user equipment information in a machine learning model as described herein, or the processor and the memory may be otherwise configured to perform or support such operations.

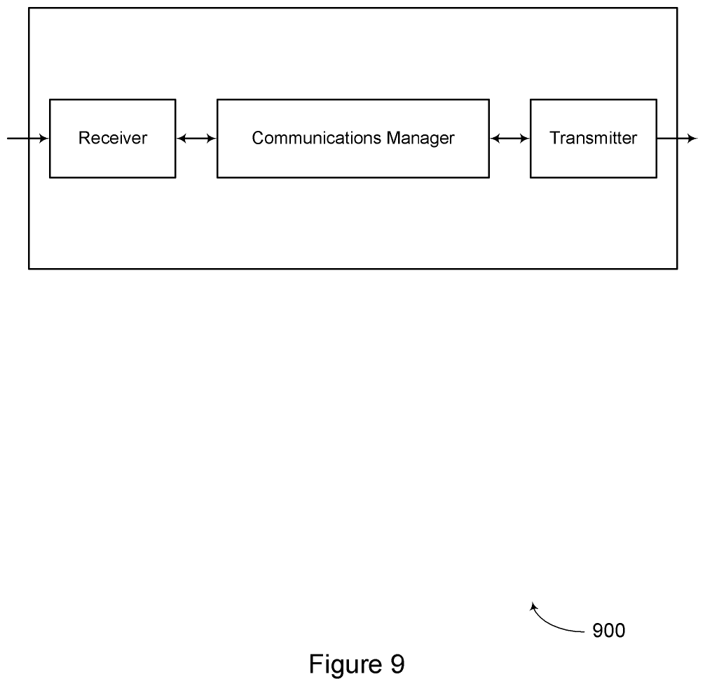

FIG. 9 shows a device that supports predictive resource management using user equipment information in a machine learning model in accordance with one or more aspects of the present disclosure. The device may be an example of aspects of a network entity 105 as described herein. The device may include a receiver, a transmitter, and a communications manager. The communications manager can be implemented, at least in part, by one or both of a modem and a processor. Each of these components may be in communication with one another (e.g., via one or more buses).

The receiver may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device. In some examples, the receiver may support obtaining information by receiving signals via one or more antennas. Additionally, or alternatively, the receiver may support obtaining information by receiving signals via one or more wired (e.g., electrical, fiber optic) interfaces, wireless interfaces, or any combination thereof.

The transmitter may provide a means for outputting (e.g., transmitting, providing, conveying, sending) information generated by other components of the device. For example, the transmitter may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter may support outputting information by transmitting signals via one or more antennas. Additionally, or alternatively, the transmitter may support outputting information by transmitting signals via one or more wired (e.g., electrical, fiber optic) interfaces, wireless interfaces, or any combination thereof. In some examples, the transmitter and the receiver may be co-located in a transceiver, which may include or be coupled with a modem.

The communications manager, the receiver, the transmitter, or various combinations thereof or various components thereof may be examples of means for performing various aspects of predictive resource management using user equipment information in a machine learning model as described herein. For example, the communications manager, the receiver, the transmitter, or various combinations or components thereof may support a method for performing one or more of the functions described herein.

In some examples, the communications manager, the receiver, the transmitter, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager, the receiver, the transmitter, or various combinations or components thereof may be implemented in code (e.g., as communications management software or firmware) executed by a processor. If implemented in code executed by a processor, the functions of the communications manager, the receiver, the transmitter, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager may be configured to perform various operations (e.g., receiving, obtaining, monitoring, outputting, transmitting) using or otherwise in cooperation with the receiver, the transmitter, or both. For example, the communications manager may receive information from the receiver, send information to the transmitter, or be integrated in combination with the receiver, the transmitter, or both to obtain information, output information, or perform various other operations as described herein.

The communications manager may support wireless communication at a network entity in accordance with examples as disclosed herein. For example, the communications manager may be configured as or otherwise support a means for receiving a set of multiple reference signals indicating information corresponding to one or more channel characteristics associated with a first set of channel measurement resources, a second set of channel measurement resources, and a direction of reception for communications, the information corresponding to a receive beam at a UE corresponding to the direction of reception for the communications. The communications manager may be configured as or otherwise support a means for training a machine learning model for obtaining a channel characteristic prediction associated with the first set of channel measurement resources based on inputting the one or more channel characteristics associated with the first set of channel measurement resources, the second set of channel measurement resources, and the direction of reception for communications to the machine learning model to obtain the channel characteristic prediction associated with the first set of channel measurement resources, the one or more channel characteristics based on the receive beam at the UE. The communications manager may be configured as or otherwise support a means for transmitting signaling indicating the machine learning model based on training the machine learning model.

Additionally, or alternatively, the communications manager may support wireless communication at a network entity in accordance with examples as disclosed herein. For example, the communications manager may be configured as or otherwise support a means for receiving information associated with one or more channel measurement resources and a direction of reception for communications at a UE. The communications manager may be configured as or otherwise support a means for training a machine learning model for obtaining a channel characteristic prediction based on inputting one or more channel characteristics and the information to the machine learning model to obtain the channel characteristic prediction. The communications manager may be configured as or otherwise support a means for transmitting signaling indicating the machine learning model based on training the machine learning model.

By including or configuring the communications manager in accordance with examples as described herein, the device (e.g., a processor controlling or otherwise coupled with the receiver, the transmitter, the communications manager, or a combination thereof) may support techniques for more efficient utilization of communication resources.

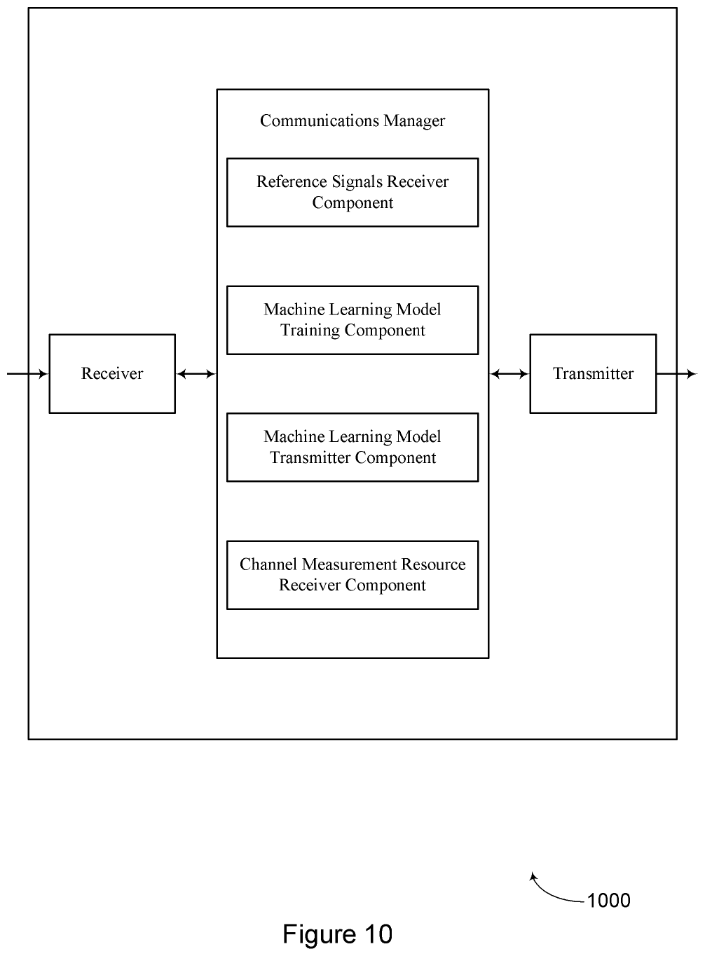

FIG. 10 shows a device that supports predictive resource management using user equipment information in a machine learning model in accordance with one or more aspects of the present disclosure. The device may be an example of aspects of a device or a network entity 105 as described herein. The device may include a receiver, a transmitter, and a communications manager. The communications manager can be implemented, at least in part, by one or both of a modem and a processor. Each of these components may be in communication with one another (e.g., via one or more buses).

The receiver may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device. In some examples, the receiver may support obtaining information by receiving signals via one or more antennas. Additionally, or alternatively, the receiver may support obtaining information by receiving signals via one or more wired (e.g., electrical, fiber optic) interfaces, wireless interfaces, or any combination thereof.

The transmitter may provide a means for outputting (e.g., transmitting, providing, conveying, sending) information generated by other components of the device. For example, the transmitter may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter may support outputting information by transmitting signals via one or more antennas. Additionally, or alternatively, the transmitter may support outputting information by transmitting signals via one or more wired (e.g., electrical, fiber optic) interfaces, wireless interfaces, or any combination thereof. In some examples, the transmitter and the receiver may be co-located in a transceiver, which may include or be coupled with a modem.

The device, or various components thereof, may be an example of means for performing various aspects of predictive resource management using user equipment information in a machine learning model as described herein. For example, the communications manager may include a reference signals receiver component, a machine learning model training component, a machine learning model transmitter component, a channel measurement resource receiver component, or any combination thereof. The communications manager may be an example of aspects of a communications manager as described herein. In some examples, the communications manager, or various components thereof, may be configured to perform various operations (e.g., receiving, obtaining, monitoring, outputting, transmitting) using or otherwise in cooperation with the receiver, the transmitter, or both. For example, the communications manager may receive information from the receiver, send information to the transmitter, or be integrated in combination with the receiver, the transmitter, or both to obtain information, output information, or perform various other operations as described herein.

The communications manager may support wireless communication at a network entity in accordance with examples as disclosed herein. The reference signals receiver component may be configured as or otherwise support a means for receiving a set of multiple reference signals indicating information corresponding to one or more channel characteristics associated with a first set of channel measurement resources, a second set of channel measurement resources, and a direction of reception for communications, the information corresponding to a receive beam at a UE corresponding to the direction of reception for the communications. The machine learning model training component may be configured as or otherwise support a means for training a machine learning model for obtaining a channel characteristic prediction associated with the first set of channel measurement resources based on inputting the one or more channel characteristics associated with the first set of channel measurement resources, the second set of channel measurement resources, and the direction of reception for communications to the machine learning model to obtain the channel characteristic prediction associated with the first set of channel measurement resources, the one or more channel characteristics based on the receive beam at the UE. The machine learning model transmitter component may be configured as or otherwise support a means for transmitting signaling indicating the machine learning model based on training the machine learning model.

Additionally, or alternatively, the communications manager may support wireless communication at a network entity in accordance with examples as disclosed herein. The channel measurement resource receiver component may be configured as or otherwise support a means for receiving information associated with one or more channel measurement resources and a direction of reception for communications at a UE. The machine learning model training component may be configured as or otherwise support a means for training a machine learning model for obtaining a channel characteristic prediction based on inputting one or more channel characteristics and the information to the machine learning model to obtain the channel characteristic prediction. The machine learning model transmitter component may be configured as or otherwise support a means for transmitting signaling indicating the machine learning model based on training the machine learning model.

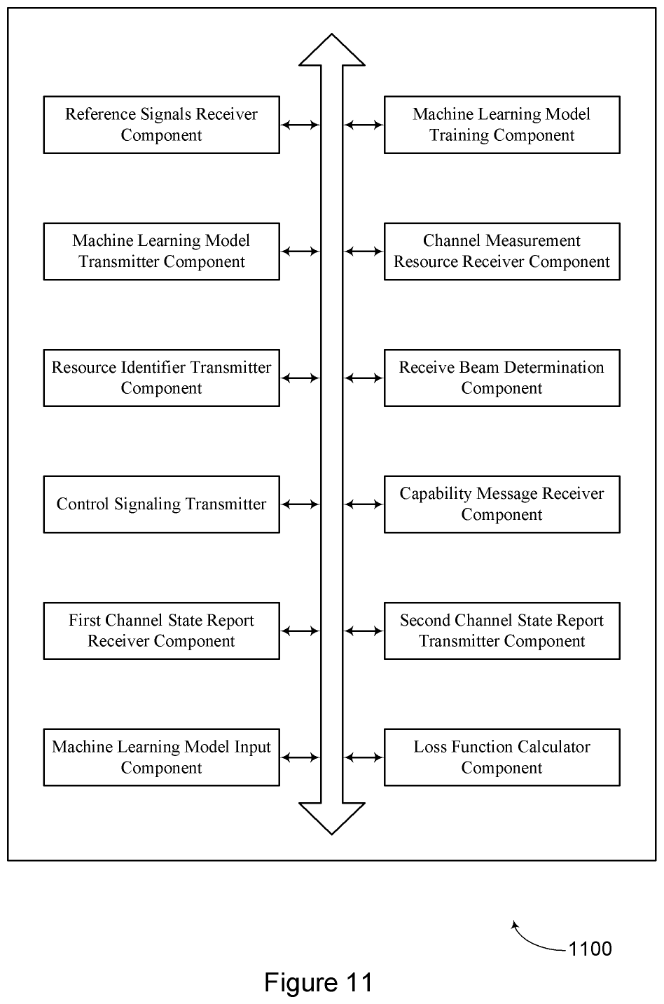

FIG. 11 shows a communications manager that supports predictive resource management using user equipment information in a machine learning model in accordance with one or more aspects of the present disclosure. The communications manager may be an example of aspects of a communications manager, a communications manager, or both, as described herein. The communications manager, or various components thereof, may be an example of means for performing various aspects of predictive resource management using user equipment information in a machine learning model as described herein. For example, the communications manager may include a reference signals receiver component, a machine learning model training component, a machine learning model transmitter component, a channel measurement resource receiver component, a resource identifier transmitter component, a receive beam determination component, a control signaling transmitter, a capability message receiver component, a first channel state report receiver component, a second channel state report transmitter component, a machine learning model input component, a loss function calculator component, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager may support wireless communication at a network entity in accordance with examples as disclosed herein. The reference signals receiver component may be configured as or otherwise support a means for receiving a set of multiple reference signals indicating information corresponding to one or more channel characteristics associated with a first set of channel measurement resources, a second set of channel measurement resources, and a direction of reception for communications, the information corresponding to a receive beam at a UE corresponding to the direction of reception for the communications. The machine learning model training component may be configured as or otherwise support a means for training a machine learning model for obtaining a channel characteristic prediction associated with the first set of channel measurement resources based on inputting the one or more channel characteristics associated with the first set of channel measurement resources, the second set of channel measurement resources, and the direction of reception for communications to the machine learning model to obtain the channel characteristic prediction associated with the first set of channel measurement resources, the one or more channel characteristics based on the receive beam at the UE. The machine learning model transmitter component may be configured as or otherwise support a means for transmitting signaling indicating the machine learning model based on training the machine learning model.

In some examples, the resource identifier transmitter component may be configured as or otherwise support a means for receiving, in a same signal as a subset the set of multiple reference signals associated with the second set of channel measurement resources, one or more channel measurement resource identifiers associated with the second set of channel measurement resources. In some examples, the receive beam determination component may be configured as or otherwise support a means for determining the receive beam at the UE for measuring the first set of channel measurement resources based on the one or more channel measurement resource identifiers.

In some examples, the reference signals receiver component may be configured as or otherwise support a means for receiving the set of multiple reference signals according to a periodicity. In some examples, the machine learning model input component may be configured as or otherwise support a means for inputting, according to the periodicity, the one or more channel characteristics and the one or more channel measurement resource identifiers to the machine learning model to obtain the channel characteristic prediction, where the channel characteristic prediction includes a reference signal receive power associated with the first set of channel measurement resources, a channel measurement resource identifier associated with the second set of channel measurement resources, or both. In some examples, the machine learning model transmitter component may be configured as or otherwise support a means for transmitting, according to the periodicity, additional signaling indicating an updated machine learning model based on inputting the one or more channel characteristics and the one or more channel measurement resource identifiers.

In some examples, the loss function calculator component may be configured as or otherwise support a means for calculating a loss function for the machine learning model using the reference signal receive power associated with the first set of channel measurement resources, a channel measurement resource identifier associated with the second set of channel measurement resources, or both.

In some examples, the reference signals receiver component may be configured as or otherwise support a means for receiving, in the same signal as the subset of the set of multiple reference signals, an indication of a reference signal receive power associated with the first set of channel measurement resources.

In some examples, the receive beam determination component may be configured as or otherwise support a means for determining a spatial filter corresponding to the receive beam based on one or more sounding reference signal resource identifiers corresponding to the second set of channel measurement resources, where the one or more channel measurement resource identifiers include the one or more sounding reference signal resource identifiers.

In some examples, the control signaling transmitter may be configured as or otherwise support a means for transmitting control signaling indicating to the UE to transmit, with the set of multiple reference signals, a set of multiple channel characteristics associated with the first set of channel measurement resources. In some examples, the reference signals receiver component may be configured as or otherwise support a means for receiving the set of multiple channel characteristics in a same signal as the set of multiple reference signals, the set of multiple channel characteristics including one or more of a reference signal receive power, a signal interference-to-noise ratio, a rank indicator, a channel quality indicator, or a precoding matrix indicator.

In some examples, the capability message receiver component may be configured as or otherwise support a means for receiving a message indicating a capability of the UE to support reporting the information corresponding to the one or more channel characteristics associated with the first set of channel measurement resources, the second set of channel measurement resources, or the direction of reception for the communications, where receiving the set of multiple reference signals indicating the information is based on the capability.

In some examples, the first channel state report receiver component may be configured as or otherwise support a means for receiving a first channel state information report of a first priority. In some examples, the second channel state report transmitter component may be configured as or otherwise support a means for receiving a second channel state information report of a second priority, the second channel state information report including the set of multiple reference signals, where the first priority is greater than the second priority.

In some examples, a first angular spread of a first reference signal of the set of multiple reference signals associated with the second set of channel measurement resources is smaller than a second angular spread of a second reference signal of the set of multiple reference signals associated with the first set of channel measurement resources.

In some examples, the set of multiple reference signals include a channel state information-reference signal, a synchronization signal block, or both.

In some examples, the one or more channel characteristics associated with the first set of channel measurement resources, the second set of channel measurement resources, and the direction of reception for communications include one or more of a time domain channel characteristic of the set of multiple reference signals, a spatial domain channel characteristic of the set of multiple reference signals, or both.

Additionally, or alternatively, the communications manager may support wireless communication at a network entity in accordance with examples as disclosed herein. The channel measurement resource receiver component may be configured as or otherwise support a means for receiving information associated with one or more channel measurement resources and a direction of reception for communications at a UE. In some examples, the machine learning model training component may be configured as or otherwise support a means for training a machine learning model for obtaining a channel characteristic prediction based on inputting one or more channel characteristics and the information to the machine learning model to obtain the channel characteristic prediction. In some examples, the machine learning model transmitter component may be configured as or otherwise support a means for transmitting signaling indicating the machine learning model based on training the machine learning model.

In some examples, the channel measurement resource receiver component may be configured as or otherwise support a means for receiving the information according to a periodicity. In some examples, the machine learning model input component may be configured as or otherwise support a means for inputting, according to the periodicity, the one or more channel characteristics and the information to the machine learning model to obtain the channel characteristic prediction, where the channel characteristic prediction includes a reference signal receive power associated with the one or more channel measurement resources, a channel measurement resource identifier, or both. In some examples, the machine learning model training component may be configured as or otherwise support a means for transmitting, according to the periodicity, additional signaling indicating an updated machine learning model based on inputting the one or more channel characteristics and the information to the machine learning model.

In some examples, the capability message receiver component may be configured as or otherwise support a means for receiving a message indicating a capability of the UE to support transmitting the information, where receiving the information is based on the capability.

In some examples, the first channel state report receiver component may be configured as or otherwise support a means for receiving a first channel state information report of a first priority. In some examples, the second channel state report transmitter component may be configured as or otherwise support a means for receiving a second channel state information report of a second priority, the second channel state information report including the information, where the first priority is greater than the second priority.

In some examples, the information includes a phase coefficient associated with a radio-frequency chain, an amplitude coefficient associated with the radio-frequency chain, a phase coefficient associated with a phase shifter, an amplitude associated with the phase shifter, an antenna panel identifier associated with the direction of reception, an orientation of an antenna panel associated with the direction of reception, a target angle of arrival for the communications, or a zenith of arrival for the communications.

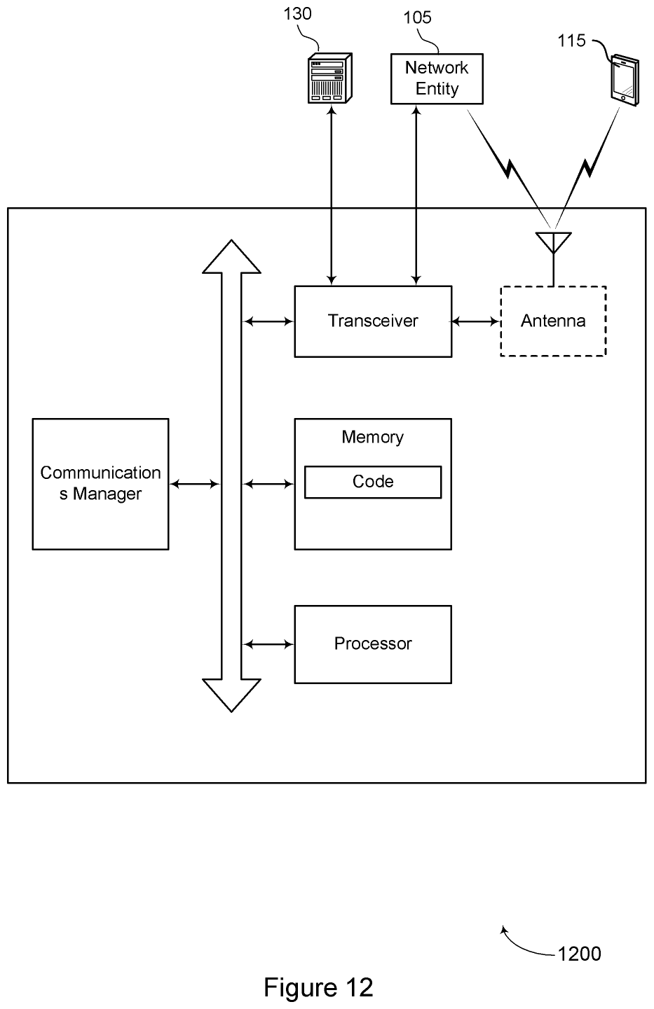

FIG. 12 shows a diagram of a system 1200 including a device that supports predictive resource management using user equipment information in a machine learning model in accordance with one or more aspects of the present disclosure. The device may be an example of or include the components of a device, a device, or a network entity 105 as described herein. The device may communicate with one or more network entities 105, one or more UEs 115, or any combination thereof, which may include communications over one or more wired interfaces, over one or more wireless interfaces, or any combination thereof. The device may include components that support outputting and obtaining communications, such as a communications manager, a transceiver, an antenna, a memory, code, and a processor. These components may be in electronic communication or otherwise coupled (e.g., operatively, communicatively, functionally, electronically, electrically) via one or more buses (e.g., a bus).

The transceiver may support bi-directional communications via wired links, wireless links, or both as described herein. In some examples, the transceiver may include a wired transceiver and may communicate bi-directionally with another wired transceiver. Additionally, or alternatively, in some examples, the transceiver may include a wireless transceiver and may communicate bi-directionally with another wireless transceiver. In some examples, the device may include one or more antennas, which may be capable of transmitting or receiving wireless transmissions (e.g., concurrently). The transceiver may also include a modem to modulate signals, to provide the modulated signals for transmission (e.g., by one or more antennas, by a wired transmitter), to receive modulated signals (e.g., from one or more antennas, from a wired receiver), and to demodulate signals. The transceiver, or the transceiver and one or more antennas or wired interfaces, where applicable, may be an example of a transmitter, a transmitter, a receiver, a receiver, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory may include RAM and ROM. The memory may store computer-readable, computer-executable code including instructions that, when executed by the processor, cause the device to perform various functions described herein. The code may be stored in a non-transitory computer-readable medium such as system memory or another type of memory. In some cases, the code may not be directly executable by the processor but may cause a computer (e.g., when compiled and executed) to perform functions described herein. In some cases, the memory may contain, among other things, a BIOS which may control basic hardware or software operation such as the interaction with peripheral components or devices.

The processor may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor may be configured to operate a memory array using a memory controller. In some other cases, a memory controller may be integrated into the processor. The processor may be configured to execute computer-readable instructions stored in a memory (e.g., the memory) to cause the device to perform various functions (e.g., functions or tasks supporting predictive resource management using user equipment information in a machine learning model). For example, the device or a component of the device may include a processor and memory coupled with the processor, the processor and memory configured to perform various functions described herein. The processor may be an example of a cloud-computing platform (e.g., one or more physical nodes and supporting software such as operating systems, virtual machines, or container instances) that may host the functions (e.g., by executing code) to perform the functions of the device.

In some examples, a bus may support communications of (e.g., within) a protocol layer of a protocol stack. In some examples, a bus may support communications associated with a logical channel of a protocol stack (e.g., between protocol layers of a protocol stack), which may include communications performed within a component of the device, or between different components of the device that may be co-located or located in different locations (e.g., where the device may refer to a system in which one or more of the communications manager, the transceiver, the memory, the code, and the processor may be located in one of the different components or divided between different components).

In some examples, the communications manager may manage aspects of communications with a core network 130 (e.g., via one or more wired or wireless backhaul links). For example, the communications manager may manage the transfer of data communications for client devices, such as one or more UEs 115. In some examples, the communications manager may manage communications with other network entities 105, and may include a controller or scheduler for controlling communications with UEs 115 in cooperation with other network entities 105. In some examples, the communications manager may support an X2 interface within an LTE/LTE-A wireless communications network technology to provide communication between network entities 105.

The communications manager may support wireless communication at a network entity in accordance with examples as disclosed herein. For example, the communications manager may be configured as or otherwise support a means for receiving a set of multiple reference signals indicating information corresponding to one or more channel characteristics associated with a first set of channel measurement resources, a second set of channel measurement resources, and a direction of reception for communications, the information corresponding to a receive beam at a UE corresponding to the direction of reception for the communications. The communications manager may be configured as or otherwise support a means for training a machine learning model for obtaining a channel characteristic prediction associated with the first set of channel measurement resources based on inputting the one or more channel characteristics associated with the first set of channel measurement resources, the second set of channel measurement resources, and the direction of reception for communications to the machine learning model to obtain the channel characteristic prediction associated with the first set of channel measurement resources, the one or more channel characteristics based on the receive beam at the UE. The communications manager may be configured as or otherwise support a means for transmitting signaling indicating the machine learning model based on training the machine learning model.

Additionally, or alternatively, the communications manager may support wireless communication at a network entity in accordance with examples as disclosed herein. For example, the communications manager may be configured as or otherwise support a means for receiving information associated with one or more channel measurement resources and a direction of reception for communications at a UE. The communications manager may be configured as or otherwise support a means for training a machine learning model for obtaining a channel characteristic prediction based on inputting one or more channel characteristics and the information to the machine learning model to obtain the channel characteristic prediction. The communications manager may be configured as or otherwise support a means for transmitting signaling indicating the machine learning model based on training the machine learning model.

By including or configuring the communications manager in accordance with examples as described herein, the device may support techniques for improved communication reliability, more efficient utilization of communication resources, and improved coordination between devices.

In some examples, the communications manager may be configured to perform various operations (e.g., receiving, obtaining, monitoring, outputting, transmitting) using or otherwise in cooperation with the transceiver, the one or more antennas (e.g., where applicable), or any combination thereof. Although the communications manager is illustrated as a separate component, in some examples, one or more functions described with reference to the communications manager may be supported by or performed by the processor, the memory, the code, the transceiver, or any combination thereof. For example, the code may include instructions executable by the processor to cause the device to perform various aspects of predictive resource management using user equipment information in a machine learning model as described herein, or the processor and the memory may be otherwise configured to perform or support such operations.

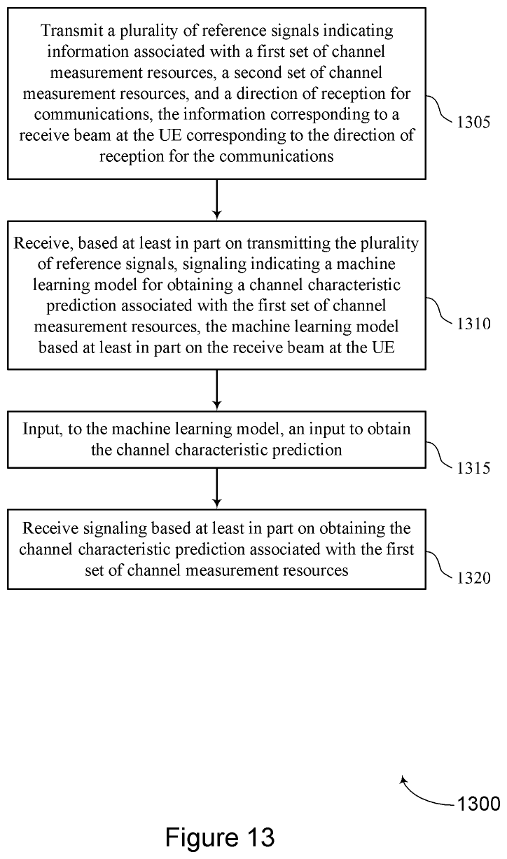

FIG. 13 shows a flowchart illustrating a method 1300 that supports predictive resource management using user equipment information in a machine learning model in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a set of multiple reference signals indicating information associated with a first set of channel measurement resources, a second set of channel measurement resources, and a direction of reception for communications, the information corresponding to a receive beam at the UE corresponding to the direction of reception for the communications. The operations of 1305 may be performed in accordance with examples as disclosed herein. In some examples, aspects of the operations of 1305 may be performed by a reference signals transmitter component as described with reference to FIG. 7.

At 1310, the method may include receiving, based on transmitting the set of multiple reference signals, signaling indicating a machine learning model for obtaining a channel characteristic prediction associated with the first set of channel measurement resources, the machine learning model based on the receive beam at the UE. The operations of 1310 may be performed in accordance with examples as disclosed herein. In some examples, aspects of the operations of 1310 may be performed by a machine learning model receiver component as described with reference to FIG. 7.

At 1315, the method may include inputting, to the machine learning model, an input to obtain the channel characteristic prediction. The operations of 1315 may be performed in accordance with examples as disclosed herein. In some examples, aspects of the operations of 1315 may be performed by a machine learning model input component as described with reference to FIG. 7.

At 1320, the method may include receiving signaling based on obtaining the channel characteristic prediction associated with the first set of channel measurement resources. The operations of 1320 may be performed in accordance with examples as disclosed herein. In some examples, aspects of the operations of 1320 may be performed by a signal receiver component as described with reference to FIG. 7.

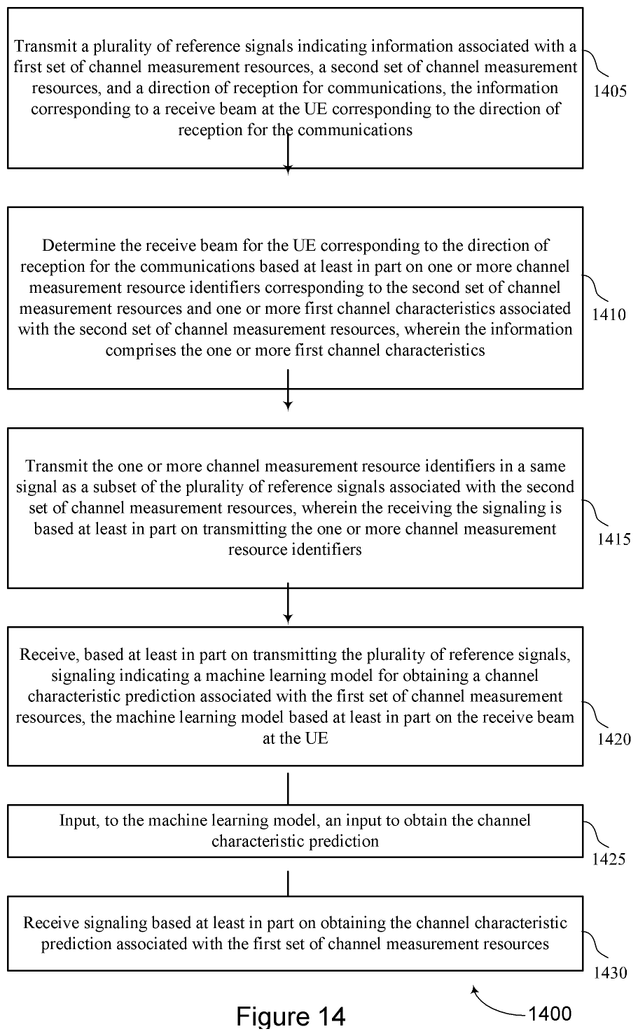

FIG. 14 shows a flowchart illustrating a method 1400 that supports predictive resource management using user equipment information in a machine learning model in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a set of multiple reference signals indicating information associated with a first set of channel measurement resources, a second set of channel measurement resources, and a direction of reception for communications, the information corresponding to a receive beam at the UE corresponding to the direction of reception for the communications. The operations of 1405 may be performed in accordance with examples as disclosed herein. In some examples, aspects of the operations of 1405 may be performed by a reference signals transmitter component as described with reference to FIG. 7.

At 1410, the method may include determining the receive beam for the UE corresponding to the direction of reception for the communications based on one or more channel measurement resource identifiers corresponding to the second set of channel measurement resources and one or more first channel characteristics associated with the second set of channel measurement resources, where the information includes the one or more first channel characteristics. The operations of 1410 may be performed in accordance with examples as disclosed herein. In some examples, aspects of the operations of 1410 may be performed by a receive beam determination component as described with reference to FIG. 7.

At 1415, the method may include transmitting the one or more channel measurement resource identifiers in a same signal as a subset of the set of multiple reference signals associated with the second set of channel measurement resources, where the receiving the signaling is based on transmitting the one or more channel measurement resource identifiers. The operations of 1415 may be performed in accordance with examples as disclosed herein. In some examples, aspects of the operations of 1415 may be performed by a resource identifier transmitter component as described with reference to FIG. 7.

At 1420, the method may include receiving, based on transmitting the set of multiple reference signals, signaling indicating a machine learning model for obtaining a channel characteristic prediction associated with the first set of channel measurement resources, the machine learning model based on the receive beam at the UE. The operations of 1420 may be performed in accordance with examples as disclosed herein. In some examples, aspects of the operations of 1420 may be performed by a machine learning model receiver component as described with reference to FIG. 7.

At 1425, the method may include inputting, to the machine learning model, an input to obtain the channel characteristic prediction. The operations of 1425 may be performed in accordance with examples as disclosed herein. In some examples, aspects of the operations of 1425 may be performed by a machine learning model input component as described with reference to FIG. 7.

At 1430, the method may include receiving signaling based on obtaining the channel characteristic prediction associated with the first set of channel measurement resources. The operations of 1430 may be performed in accordance with examples as disclosed herein. In some examples, aspects of the operations of 1430 may be performed by a signal receiver component as described with reference to FIG. 7.

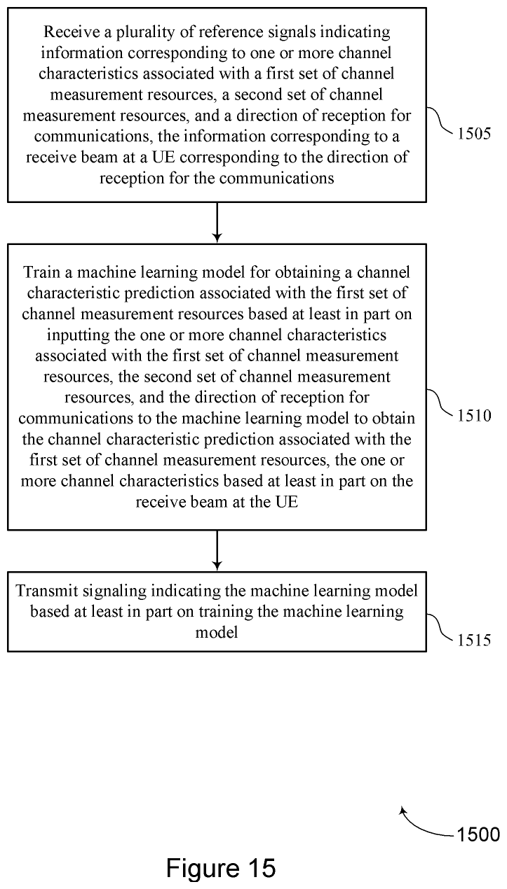

FIG. 15 shows a flowchart illustrating a method 1500 that supports predictive resource management using user equipment information in a machine learning model in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving a set of multiple reference signals indicating information corresponding to one or more channel characteristics associated with a first set of channel measurement resources, a second set of channel measurement resources, and a direction of reception for communications, the information corresponding to a receive beam at a UE corresponding to the direction of reception for the communications. The operations of 1505 may be performed in accordance with examples as disclosed herein. In some examples, aspects of the operations of 1505 may be performed by a reference signals receiver component as described with reference to FIG. 11.

At 1510, the method may include training a machine learning model for obtaining a channel characteristic prediction associated with the first set of channel measurement resources based on inputting the one or more channel characteristics associated with the first set of channel measurement resources, the second set of channel measurement resources, and the direction of reception for communications to the machine learning model to obtain the channel characteristic prediction associated with the first set of channel measurement resources, the one or more channel characteristics based on the receive beam at the UE. The operations of 1510 may be performed in accordance with examples as disclosed herein. In some examples, aspects of the operations of 1510 may be performed by a machine learning model training component as described with reference to FIG. 11.

At 1515, the method may include transmitting signaling indicating the machine learning model based on training the machine learning model. The operations of 1515 may be performed in accordance with examples as disclosed herein. In some examples, aspects of the operations of 1515 may be performed by a machine learning model transmitter component as described with reference to FIG. 11.

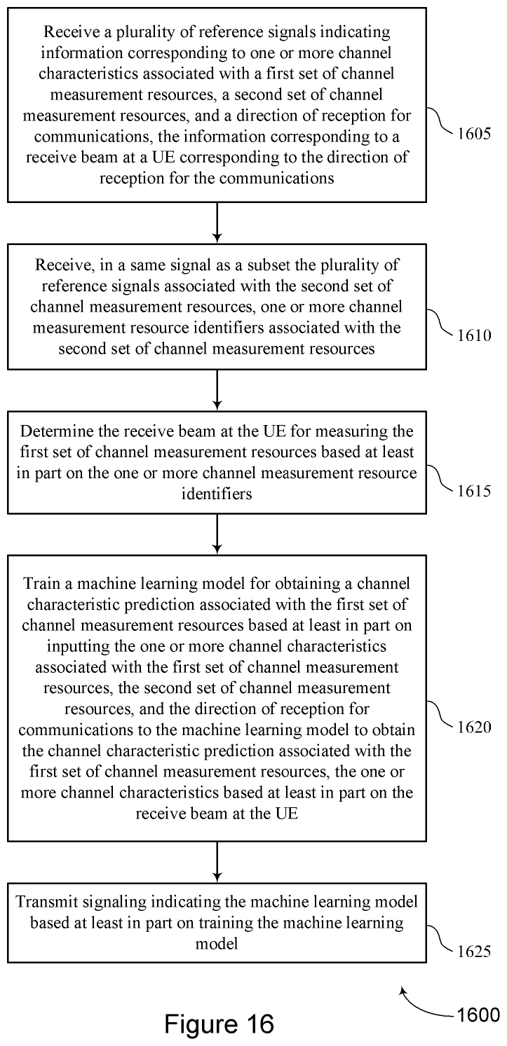

FIG. 16 shows a flowchart illustrating a method 1600 that supports predictive resource management using user equipment information in a machine learning model in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a set of multiple reference signals indicating information corresponding to one or more channel characteristics associated with a first set of channel measurement resources, a second set of channel measurement resources, and a direction of reception for communications, the information corresponding to a receive beam at a UE corresponding to the direction of reception for the communications. The operations of 1605 may be performed in accordance with examples as disclosed herein. In some examples, aspects of the operations of 1605 may be performed by a reference signals receiver component as described with reference to FIG. 11.

At 1610, the method may include receiving, in a same signal as a subset the set of multiple reference signals associated with the second set of channel measurement resources, one or more channel measurement resource identifiers associated with the second set of channel measurement resources. The operations of 1610 may be performed in accordance with examples as disclosed herein. In some examples, aspects of the operations of 1610 may be performed by a resource identifier transmitter component as described with reference to FIG. 11.

At 1615, the method may include determining the receive beam at the UE for measuring the first set of channel measurement resources based on the one or more channel measurement resource identifiers. The operations of 1615 may be performed in accordance with examples as disclosed herein. In some examples, aspects of the operations of 1615 may be performed by a receive beam determination component as described with reference to FIG. 11.

At 1620, the method may include training a machine learning model for obtaining a channel characteristic prediction associated with the first set of channel measurement resources based on inputting the one or more channel characteristics associated with the first set of channel measurement resources, the second set of channel measurement resources, and the direction of reception for communications to the machine learning model to obtain the channel characteristic prediction associated with the first set of channel measurement resources, the one or more channel characteristics based on the receive beam at the UE. The operations of 1620 may be performed in accordance with examples as disclosed herein. In some examples, aspects of the operations of 1620 may be performed by a machine learning model training component as described with reference to FIG. 11.

At 1625, the method may include transmitting signaling indicating the machine learning model based on training the machine learning model. The operations of 1625 may be performed in accordance with examples as disclosed herein. In some examples, aspects of the operations of 1625 may be performed by a machine learning model transmitter component as described with reference to FIG. 11.

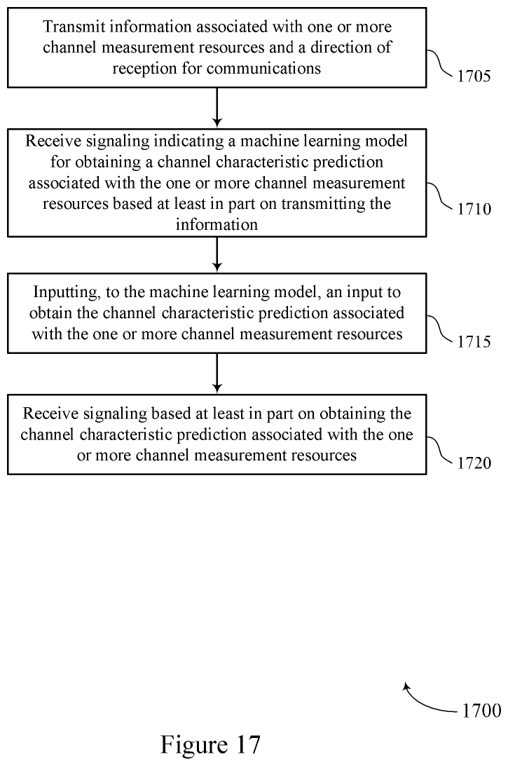

FIG. 17 shows a flowchart illustrating a method 1700 that supports predictive resource management using user equipment information in a machine learning model in accordance with one or more aspects of the present disclosure. The operations of the method 1700 may be implemented by a UE or its components as described herein. For example, the operations of the method 1700 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1705, the method may include transmitting information associated with one or more channel measurement resources and a direction of reception for communications. The operations of 1705 may be performed in accordance with examples as disclosed herein. In some examples, aspects of the operations of 1705 may be performed by a channel measurement resource transmitter component as described with reference to FIG. 7.

At 1710, the method may include receiving signaling indicating a machine learning model for obtaining a channel characteristic prediction associated with the one or more channel measurement resources based on transmitting the information. The operations of 1710 may be performed in accordance with examples as disclosed herein. In some examples, aspects of the operations of 1710 may be performed by a machine learning model receiver component as described with reference to FIG. 7.

At 1715, the method may include inputting, to the machine learning model, an input to obtain the channel characteristic prediction associated with the one or more channel measurement resources. The operations of 1715 may be performed in accordance with examples as disclosed herein. In some examples, aspects of the operations of 1715 may be performed by a machine learning model input component as described with reference to FIG. 7.

At 1720, the method may include receiving signaling based on obtaining the channel characteristic prediction associated with the one or more channel measurement resources. The operations of 1720 may be performed in accordance with examples as disclosed herein. In some examples, aspects of the operations of 1720 may be performed by a signal receiver component as described with reference to FIG. 7.

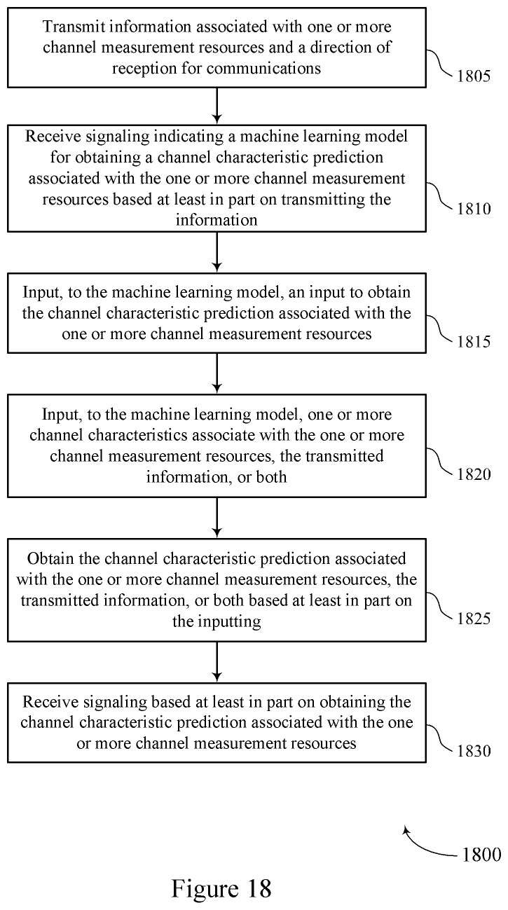

FIG. 18 shows a flowchart illustrating a method 1800 that supports predictive resource management using user equipment information in a machine learning model in accordance with one or more aspects of the present disclosure. The operations of the method 1800 may be implemented by a UE or its components as described herein. For example, the operations of the method 1800 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1805, the method may include transmitting information associated with one or more channel measurement resources and a direction of reception for communications. The operations of 1805 may be performed in accordance with examples as disclosed herein. In some examples, aspects of the operations of 1805 may be performed by a channel measurement resource transmitter component as described with reference to FIG. 7.

At 1810, the method may include receiving signaling indicating a machine learning model for obtaining a channel characteristic prediction associated with the one or more channel measurement resources based on transmitting the information. The operations of 1810 may be performed in accordance with examples as disclosed herein. In some examples, aspects of the operations of 1810 may be performed by a machine learning model receiver component as described with reference to FIG. 7.

At 1815, the method may include inputting, to the machine learning model, an input to obtain the channel characteristic prediction associated with the one or more channel measurement resources. The operations of 1815 may be performed in accordance with examples as disclosed herein. In some examples, aspects of the operations of 1815 may be performed by a machine learning model input component as described with reference to FIG. 7.

At 1820, the method may include inputting, to the machine learning model, one or more channel characteristics associated with the one or more channel measurement resources, the transmitted information, or both. The operations of 1820 may be performed in accordance with examples as disclosed herein. In some examples, aspects of the operations of 1820 may be performed by a machine learning model input component as described with reference to FIG. 7.

At 1825, the method may include obtaining the channel characteristic prediction associated with the one or more channel measurement resources, the transmitted information, or both based on the inputting. The operations of 1825 may be performed in accordance with examples as disclosed herein. In some examples, aspects of the operations of 1825 may be performed by a prediction obtain component as described with reference to FIG. 7.

At 1830, the method may include receiving signaling based on obtaining the channel characteristic prediction associated with the one or more channel measurement resources. The operations of 1830 may be performed in accordance with examples as disclosed herein. In some examples, aspects of the operations of 1830 may be performed by a signal receiver component as described with reference to FIG. 7.

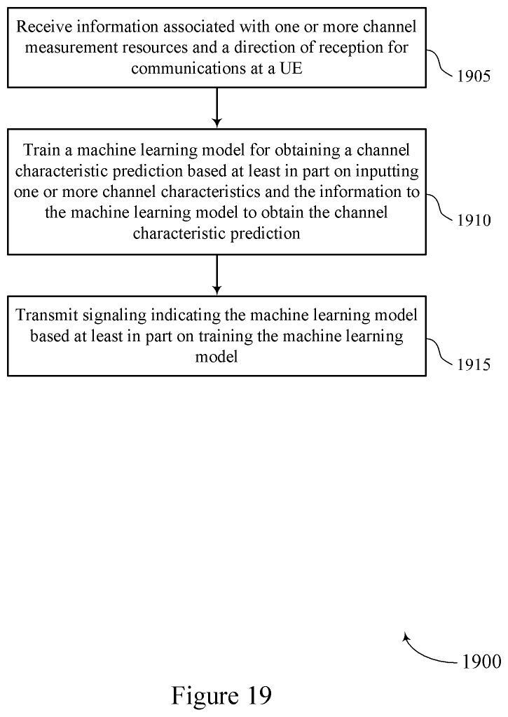

FIG. 19 shows a flowchart illustrating a method 1900 that supports predictive resource management using user equipment information in a machine learning model in accordance with one or more aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include receiving information associated with one or more channel measurement resources and a direction of reception for communications at a UE. The operations of 1905 may be performed in accordance with examples as disclosed herein. In some examples, aspects of the operations of 1905 may be performed by a channel measurement resource receiver component as described with reference to FIG. 11.

At 1910, the method may include training a machine learning model for obtaining a channel characteristic prediction based on inputting one or more channel characteristics and the information to the machine learning model to obtain the channel characteristic prediction. The operations of 1910 may be performed in accordance with examples as disclosed herein. In some examples, aspects of the operations of 1910 may be performed by a machine learning model training component as described with reference to FIG. 11.

At 1915, the method may include transmitting signaling indicating the machine learning model based on training the machine learning model. The operations of 1915 may be performed in accordance with examples as disclosed herein. In some examples, aspects of the operations of 1915 may be performed by a machine learning model transmitter component as described with reference to FIG. 11.

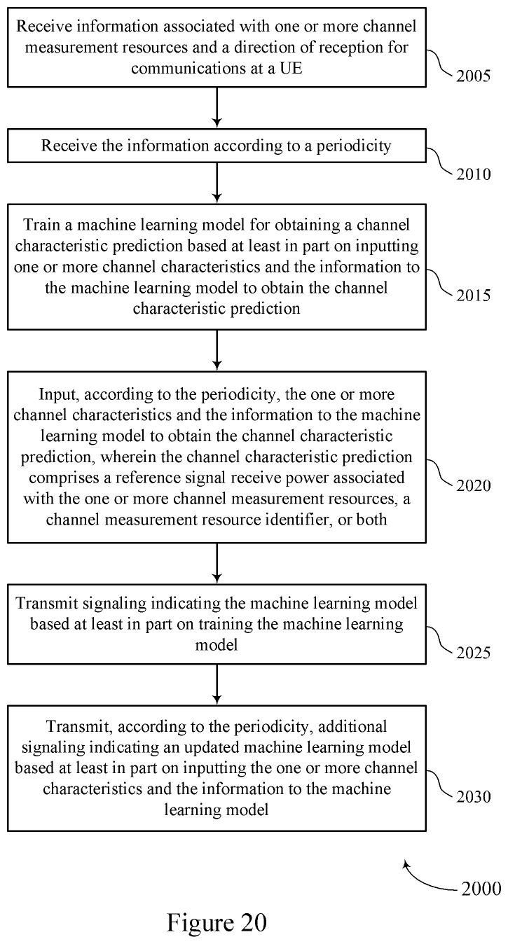

FIG. 20 shows a flowchart illustrating a method 2000 that supports predictive resource management using user equipment information in a machine learning model in accordance with one or more aspects of the present disclosure. The operations of the method 2000 may be implemented by a network entity or its components as described herein. For example, the operations of the method 2000 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2005, the method may include receiving information associated with one or more channel measurement resources and a direction of reception for communications at a UE. The operations of 2005 may be performed in accordance with examples as disclosed herein. In some examples, aspects of the operations of 2005 may be performed by a channel measurement resource receiver component as described with reference to FIG. 11.

At 2010, the method may include receiving the information according to a periodicity. The operations of 2010 may be performed in accordance with examples as disclosed herein. In some examples, aspects of the operations of 2010 may be performed by a channel measurement resource receiver component as described with reference to FIG. 11.

At 2015, the method may include training a machine learning model for obtaining a channel characteristic prediction based on inputting one or more channel characteristics and the information to the machine learning model to obtain the channel characteristic prediction. The operations of 2015 may be performed in accordance with examples as disclosed herein. In some examples, aspects of the operations of 2015 may be performed by a machine learning model training component as described with reference to FIG. 11.

At 2020, the method may include inputting, according to the periodicity, the one or more channel characteristics and the information to the machine learning model to obtain the channel characteristic prediction, where the channel characteristic prediction includes a reference signal receive power associated with the one or more channel measurement resources, a channel measurement resource identifier, or both. The operations of 2020 may be performed in accordance with examples as disclosed herein. In some examples, aspects of the operations of 2020 may be performed by a machine learning model input component as described with reference to FIG. 11.

At 2025, the method may include transmitting signaling indicating the machine learning model based on training the machine learning model. The operations of 2025 may be performed in accordance with examples as disclosed herein. In some examples, aspects of the operations of 2025 may be performed by a machine learning model transmitter component as described with reference to FIG. 11.

At 2030, the method may include transmitting, according to the periodicity, additional signaling indicating an updated machine learning model based on inputting the one or more channel characteristics and the information to the machine learning model. The operations of 2030 may be performed in accordance with examples as disclosed herein. In some examples, aspects of the operations of 2030 may be performed by a machine learning model training component as described with reference to FIG. 11.

The following provides an overview of aspects of the present disclosure:

Aspect 1: A method for wireless communication at a UE, comprising: transmitting a plurality of reference signals indicating information associated with a first set of channel measurement resources, a second set of channel measurement resources, and a direction of reception for communications, the information corresponding to a receive beam at the UE corresponding to the direction of reception for the communications; receiving, based at least in part on transmitting the plurality of reference signals, signaling indicating a machine learning model for obtaining a channel characteristic prediction associated with the first set of channel measurement resources, the machine learning model based at least in part on the receive beam at the UE; inputting, to the machine learning model, an input to obtain the channel characteristic prediction; and receiving signaling based at least in part on obtaining the channel characteristic prediction associated with the first set of channel measurement resources.

Aspect 2: The method of aspect 1, further comprising: determining the receive beam for the UE corresponding to the direction of reception for the communications based at least in part on one or more channel measurement resource identifiers corresponding to the second set of channel measurement resources and one or more first channel characteristics associated with the second set of channel measurement resources, wherein the information comprises the one or more first channel characteristics; and transmitting the one or more channel measurement resource identifiers in a same signal as a subset of the plurality of reference signals associated with the second set of channel measurement resources, wherein the receiving the signaling is based at least in part on transmitting the one or more channel measurement resource identifiers.

Aspect 3: The method of aspect 2, further comprising: inputting, to the machine learning model based at least in part on transmitting the plurality of reference signals, the one or more channel measurement resource identifiers, one or more second channel characteristics associated with the first set of channel measurement resources, or both; and obtaining the channel characteristic prediction associated with the first set of channel measurement resources based at least in part on inputting the one or more channel measurement resource identifiers, the one or more second channel characteristics associated with the first set of channel measurement resources, or both.

Aspect 4: The method of any of aspects 2 through 3, further comprising: transmitting, in the same signal as the subset of the plurality of reference signals, an indication of a reference signal receive power associated with the first set of channel measurement resources.

Aspect 5: The method of any of aspects 2 through 4, wherein the one or more first channel characteristics comprise one or more reference signal receive power values for the subset of the plurality of reference signals.

Aspect 6: The method of any of aspects 2 through 5, further comprising: determining a spatial filter corresponding to the receive beam based at least in part on one or more sounding reference signal resource identifiers corresponding to the second set of channel measurement resources, wherein the one or more channel measurement resource identifiers comprise the one or more sounding reference signal resource identifiers.

Aspect 7: The method of any of aspects 1 through 6, further comprising: receiving control signaling indicating to the UE to transmit, with the plurality of reference signals, a plurality of channel characteristics associated with the first set of channel measurement resources; and transmitting the plurality of channel characteristics in a same signal as the plurality of reference signals, the plurality of channel characteristics comprising one or more of a reference signal receive power, a signal interference-to-noise ratio, a rank indicator, a channel quality indicator, or a precoding matrix indicator.

Aspect 8: The method of any of aspects 1 through 7, further comprising: transmitting a message indicating a capability of the UE to support reporting the information associated with the first set of channel measurement resources, the second set of channel measurement resources, or the direction of reception for the communications, wherein transmitting the plurality of reference signals indicating the information is based at least in part on the capability.

Aspect 9: The method of any of aspects 1 through 8, further comprising: transmitting the plurality of reference signals according to a periodicity; and receiving, according to the periodicity, additional signaling indicating an update to the machine learning model based at least in part on transmitting the plurality of reference signals.

Aspect 10: The method of any of aspects 1 through 9, further comprising: transmitting a first channel state information report of a first priority; and transmitting a second channel state information report of a second priority, the second channel state information report comprising the information, wherein the first priority is greater than the second priority.

Aspect 11: The method of any of aspects 1 through 10, wherein a first angular spread of a first reference signal of the plurality of reference signals associated with the second set of channel measurement resources is smaller than a second angular spread of a second reference signal of the plurality of reference signals associated with the first set of channel measurement resources.

Aspect 12: The method of any of aspects 1 through 11, wherein the plurality of reference signals comprise a channel state information-reference signal, a synchronization signal block, or both.

Aspect 13: The method of any of aspects 1 through 12, wherein the channel characteristic prediction associated with the first set of channel measurement resources is for a time domain channel characteristic of the plurality of reference signals, a spatial domain channel characteristic of the plurality of reference signals, or both.

Aspect 14: A method for wireless communication at a network entity, comprising: receiving a plurality of reference signals indicating information corresponding to one or more channel characteristics associated with a first set of channel measurement resources, a second set of channel measurement resources, and a direction of reception for communications, the information corresponding to a receive beam at a UE corresponding to the direction of reception for the communications; training a machine learning model for obtaining a channel characteristic prediction associated with the first set of channel measurement resources based at least in part on inputting the one or more channel characteristics associated with the first set of channel measurement resources, the second set of channel measurement resources, and the direction of reception for communications to the machine learning model to obtain the channel characteristic prediction associated with the first set of channel measurement resources, the one or more channel characteristics based at least in part on the receive beam at the UE; and transmitting signaling indicating the machine learning model based at least in part on training the machine learning model.

Aspect 15: The method of aspect 14, further comprising: receiving, in a same signal as a subset the plurality of reference signals associated with the second set of channel measurement resources, one or more channel measurement resource identifiers associated with the second set of channel measurement resources; and determining the receive beam at the UE for measuring the first set of channel measurement resources based at least in part on the one or more channel measurement resource identifiers.

Aspect 16: The method of aspect 15, further comprising: receiving the plurality of reference signals according to a periodicity; inputting, according to the periodicity, the one or more channel characteristics and the one or more channel measurement resource identifiers to the machine learning model to obtain the channel characteristic prediction, wherein the channel characteristic prediction comprises a reference signal receive power associated with the first set of channel measurement resources, a channel measurement resource identifier associated with the second set of channel measurement resources, or both; and transmitting, according to the periodicity, additional signaling indicating an updated machine learning model based at least in part on inputting the one or more channel characteristics and the one or more channel measurement resource identifiers.

Aspect 17: The method of aspect 16, further comprising: calculating a loss function for the machine learning model using the reference signal receive power associated with the first set of channel measurement resources, a channel measurement resource identifier associated with the second set of channel measurement resources, or both.

Aspect 18: The method of any of aspects 15 through 17, further comprising: receiving, in the same signal as the subset of the plurality of reference signals, an indication of a reference signal receive power associated with the first set of channel measurement resources.

Aspect 19: The method of any of aspects 15 through 18, further comprising: determining a spatial filter corresponding to the receive beam based at least in part on one or more sounding reference signal resource identifiers corresponding to the second set of channel measurement resources, wherein the one or more channel measurement resource identifiers comprise the one or more sounding reference signal resource identifiers.

Aspect 20: The method of any of aspects 14 through 19, further comprising: transmitting control signaling indicating to the UE to transmit, with the plurality of reference signals, a plurality of channel characteristics associated with the first set of channel measurement resources; and receiving the plurality of channel characteristics in a same signal as the plurality of reference signals, the plurality of channel characteristics comprising one or more of a reference signal receive power, a signal interference-to-noise ratio, a rank indicator, a channel quality indicator, or a precoding matrix indicator.

Aspect 21: The method of any of aspects 14 through 20, further comprising: receiving a message indicating a capability of the UE to support reporting the information corresponding to the one or more channel characteristics associated with the first set of channel measurement resources, the second set of channel measurement resources, or the direction of reception for the communications, wherein receiving the plurality of reference signals indicating the information is based at least in part on the capability.

Aspect 22: The method of any of aspects 14 through 21, further comprising: receiving a first channel state information report of a first priority; and receiving a second channel state information report of a second priority, the second channel state information report comprising the plurality of reference signals, wherein the first priority is greater than the second priority.

Aspect 23: The method of any of aspects 14 through 22, wherein a first angular spread of a first reference signal of the plurality of reference signals associated with the second set of channel measurement resources is smaller than a second angular spread of a second reference signal of the plurality of reference signals associated with the first set of channel measurement resources.

Aspect 24: The method of any of aspects 14 through 23, wherein the plurality of reference signals comprise a channel state information-reference signal, a synchronization signal block, or both.

Aspect 25: The method of any of aspects 14 through 24, wherein the one or more channel characteristics associated with the first set of channel measurement resources, the second set of channel measurement resources, and the direction of reception for communications comprise one or more of a time domain channel characteristic of the plurality of reference signals, a spatial domain channel characteristic of the plurality of reference signals, or both.

Aspect 26: A method for wireless communication at a UE, comprising: transmitting information associated with one or more channel measurement resources and a direction of reception for communications; receiving signaling indicating a machine learning model for obtaining a channel characteristic prediction associated with the one or more channel measurement resources based at least in part on transmitting the information; inputting, to the machine learning model, an input to obtain the channel characteristic prediction associated with the one or more channel measurement resources; and receiving signaling based at least in part on obtaining the channel characteristic prediction associated with the one or more channel measurement resources.

Aspect 27: The method of aspect 26, further comprising: inputting, to the machine learning model, one or more channel characteristics associated with the one or more channel measurement resources, the transmitted information, or both; and obtaining the channel characteristic prediction associated with the one or more channel measurement resources, the transmitted information, or both based at least in part on the inputting.

Aspect 28: The method of any of aspects 26 through 27, further comprising: transmitting a message indicating a capability of the UE to support transmitting the information, wherein transmitting the information is based at least in part on the capability.

Aspect 29: The method of any of aspects 26 through 28, further comprising: transmitting the information according to a periodicity; and receiving, according to the periodicity, additional signaling indicating an update to the machine learning model based at least in part on transmitting the information.

Aspect 30: The method of any of aspects 26 through 29, further comprising: transmitting a first channel state information report of a first priority; and transmitting a second channel state information report of a second priority, the second channel state information report comprising the information, wherein the first priority is greater than the second priority.

Aspect 31: The method of any of aspects 26 through 30, wherein the information comprises a phase coefficient associated with a radio-frequency chain, an amplitude coefficient associated with the radio-frequency chain, a phase coefficient associated with a phase shifter, an amplitude associated with the phase shifter, an antenna panel identifier associated with the direction of reception, an orientation of an antenna panel associated with the direction of reception, a target angle of arrival for the communications, or a zenith of arrival for the communications.

Aspect 32: A method for wireless communication at a network entity, comprising: receiving information associated with one or more channel measurement resources and a direction of reception for communications at a UE; training a machine learning model for obtaining a channel characteristic prediction based at least in part on inputting one or more channel characteristics and the information to the machine learning model to obtain the channel characteristic prediction; and transmitting signaling indicating the machine learning model based at least in part on training the machine learning model.

Aspect 33: The method of aspect 32, further comprising: receiving the information according to a periodicity; inputting, according to the periodicity, the one or more channel characteristics and the information to the machine learning model to obtain the channel characteristic prediction, wherein the channel characteristic prediction comprises a reference signal receive power associated with the one or more channel measurement resources, a channel measurement resource identifier, or both; and transmitting, according to the periodicity, additional signaling indicating an updated machine learning model based at least in part on inputting the one or more channel characteristics and the information to the machine learning model.

Aspect 34: The method of any of aspects 32 through 33, further comprising: receiving a message indicating a capability of the UE to support transmitting the information, wherein receiving the information is based at least in part on the capability.

Aspect 35: The method of any of aspects 32 through 34, further comprising: receiving a first channel state information report of a first priority; and receiving a second channel state information report of a second priority, the second channel state information report comprising the information, wherein the first priority is greater than the second priority.

Aspect 36: The method of any of aspects 32 through 35, wherein the information comprises a phase coefficient associated with a radio-frequency chain, an amplitude coefficient associated with the radio-frequency chain, a phase coefficient associated with a phase shifter, an amplitude associated with the phase shifter, an antenna panel identifier associated with the direction of reception, an orientation of an antenna panel associated with the direction of reception, a target angle of arrival for the communications, or a zenith of arrival for the communications.

Aspect 37: An apparatus for wireless communication at a UE, comprising a processor; memory coupled with the processor; and instructions stored in the memory and executable by the processor to cause the apparatus to perform a method of any of aspects 1 through 13.

Aspect 38: An apparatus for wireless communication at a UE, comprising at least one means for performing a method of any of aspects 1 through 13.

Aspect 39: A non-transitory computer-readable medium storing code for wireless communication at a UE, the code comprising instructions executable by a processor to perform a method of any of aspects 1 through 13.

Aspect 40: An apparatus for wireless communication at a network entity, comprising a processor; memory coupled with the processor; and instructions stored in the memory and executable by the processor to cause the apparatus to perform a method of any of aspects 14 through 25.

Aspect 41: An apparatus for wireless communication at a network entity, comprising at least one means for performing a method of any of aspects 14 through 25.

Aspect 42: A non-transitory computer-readable medium storing code for wireless communication at a network entity, the code comprising instructions executable by a processor to perform a method of any of aspects 14 through 25.

Aspect 43: An apparatus for wireless communication at a UE, comprising a processor; memory coupled with the processor; and instructions stored in the memory and executable by the processor to cause the apparatus to perform a method of any of aspects 26 through 31.

Aspect 44: An apparatus for wireless communication at a UE, comprising at least one means for performing a method of any of aspects 26 through 31.

Aspect 45: A non-transitory computer-readable medium storing code for wireless communication at a UE, the code comprising instructions executable by a processor to perform a method of any of aspects 26 through 31.

Aspect 46: An apparatus for wireless communication at a network entity, comprising a processor; memory coupled with the processor; and instructions stored in the memory and executable by the processor to cause the apparatus to perform a method of any of aspects 32 through 36.

Aspect 47: An apparatus for wireless communication at a network entity, comprising at least one means for performing a method of any of aspects 32 through 36.

Aspect 48: A non-transitory computer-readable medium storing code for wireless communication at a network entity, the code comprising instructions executable by a processor to perform a method of any of aspects 32 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc in which disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and “determining” can include calculating, computing, processing, deriving, investigating, looking up (such as via looking up in a table, a database or another data structure), ascertaining among other examples. Also, “determining” can include receiving (such as receiving information), accessing (such as accessing data in a memory) among other examples. Also, “determining” can include resolving, obtaining, selecting, choosing, establishing and other such similar actions.

In the appended Figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. The disclosure is not limited to the examples and designs described herein but is to be accorded the broadest scope consistent with the principles and novel features disclosed herein.

What is claimed is:

1. A method for wireless communication at a user equipment (UE), comprising:
transmitting a plurality of reference signals indicating information associated with a first set of channel measurement resources, a second set of channel measurement resources, and a direction of reception for communications, the information corresponding to a receive beam at the UE corresponding to the direction of reception for the communications;
receiving, based at least in part on transmitting the plurality of reference signals, signaling indicating a machine learning model for obtaining a channel characteristic prediction associated with the first set of channel measurement resources, the machine learning model based at least in part on the receive beam at the UE;
inputting, to the machine learning model, an input to obtain the channel characteristic prediction; and
receiving signaling based at least in part on obtaining the channel characteristic prediction associated with the first set of channel measurement resources.

2. The method of claim 1, further comprising:
determining the receive beam for the UE corresponding to the direction of reception for the communications based at least in part on one or more channel measurement resource identifiers corresponding to the second set of channel measurement resources and one or more first channel characteristics associated with the second set of channel measurement resources, wherein the information comprises the one or more first channel characteristics; and
transmitting the one or more channel measurement resource identifiers in a same signal as a subset of the plurality of reference signals associated with the second set of channel measurement resources, wherein the receiving the signaling is based at least in part on transmitting the one or more channel measurement resource identifiers.

3. The method of claim 2, further comprising:
inputting, to the machine learning model based at least in part on transmitting the plurality of reference signals, the one or more channel measurement resource identifiers, one or more second channel characteristics associated with the first set of channel measurement resources, or both; and
obtaining the channel characteristic prediction associated with the first set of channel measurement resources based at least in part on inputting the one or more channel measurement resource identifiers, the one or more second channel characteristics associated with the first set of channel measurement resources, or both.

4. The method of claim 2, further comprising:
transmitting, in the same signal as the subset of the plurality of reference signals, an indication of a reference signal receive power associated with the first set of channel measurement resources.

5. The method of claim 2, wherein the one or more first channel characteristics comprise one or more reference signal receive power values for the subset of the plurality of reference signals.

6. The method of claim 2, further comprising:
determining a spatial filter corresponding to the receive beam based at least in part on one or more sounding reference signal resource identifiers corresponding to the second set of channel measurement resources, wherein the one or more channel measurement resource identifiers comprise the one or more sounding reference signal resource identifiers.

7. The method of claim 1, further comprising:
receiving control signaling indicating to the UE to transmit, with the plurality of reference signals, a plurality of channel characteristics associated with the first set of channel measurement resources; and
transmitting the plurality of channel characteristics in a same signal as the plurality of reference signals, the plurality of channel characteristics comprising one or more of a reference signal receive power, a signal interference-to-noise ratio, a rank indicator, a channel quality indicator, or a precoding matrix indicator.

8. The method of claim 1, further comprising:
transmitting a message indicating a capability of the UE to support reporting the information associated with the first set of channel measurement resources, the second set of channel measurement resources, or the direction of reception for the communications, wherein transmitting the plurality of reference signals indicating the information is based at least in part on the capability.

9. The method of claim 1, further comprising:
transmitting the plurality of reference signals according to a periodicity; and
receiving, according to the periodicity, additional signaling indicating an update to the machine learning model based at least in part on transmitting the plurality of reference signals.

10. The method of claim 1, further comprising:
transmitting a first channel state information report of a first priority; and
transmitting a second channel state information report of a second priority, the second channel state information report comprising the information, wherein the first priority is greater than the second priority.

11. The method of claim 1, wherein a first angular spread of a first reference signal of the plurality of reference signals associated with the second set of channel measurement resources is smaller than a second angular spread of a second reference signal of the plurality of reference signals associated with the first set of channel measurement resources.

12. The method of claim 1, wherein the plurality of reference signals comprise a channel state information-reference signal, a synchronization signal block, or both.

13. The method of claim 1, wherein the channel characteristic prediction associated with the first set of channel measurement resources is for a time domain channel characteristic of the plurality of reference signals, a spatial domain channel characteristic of the plurality of reference signals, or both.

14. A method for wireless communication at a network entity, comprising:
receiving a plurality of reference signals indicating information corresponding to one or more channel characteristics associated with a first set of channel measurement resources, a second set of channel measurement resources, and a direction of reception for communications, the information corresponding to a receive beam at a user equipment (UE) corresponding to the direction of reception for the communications;
training a machine learning model for obtaining a channel characteristic prediction associated with the first set of channel measurement resources based at least in part on inputting the one or more channel characteristics associated with the first set of channel measurement resources, the second set of channel measurement resources, and the direction of reception for communications to the machine learning model to obtain the channel characteristic prediction associated with the first set of channel measurement resources, the one or more channel characteristics based at least in part on the receive beam at the UE; and
transmitting signaling indicating the machine learning model based at least in part on training the machine learning model.

15. The method of claim 14, further comprising:
receiving, in a same signal as a subset the plurality of reference signals associated with the second set of channel measurement resources, one or more channel measurement resource identifiers associated with the second set of channel measurement resources; and
determining the receive beam at the UE for measuring the first set of channel measurement resources based at least in part on the one or more channel measurement resource identifiers.

16. The method of claim 15, further comprising:
receiving the plurality of reference signals according to a periodicity;
inputting, according to the periodicity, the one or more channel characteristics and the one or more channel measurement resource identifiers to the machine learning model to obtain the channel characteristic prediction, wherein the channel characteristic prediction comprises a reference signal receive power associated with the first set of channel measurement resources, a channel measurement resource identifier associated with the second set of channel measurement resources, or both; and
transmitting, according to the periodicity, additional signaling indicating an updated machine learning model based at least in part on inputting the one or more channel characteristics and the one or more channel measurement resource identifiers.

17. The method of claim 16, further comprising:
calculating a loss function for the machine learning model using the reference signal receive power associated with the first set of channel measurement resources, a channel measurement resource identifier associated with the second set of channel measurement resources, or both.

18. The method of claim 15, further comprising:
receiving, in the same signal as the subset of the plurality of reference signals, an indication of a reference signal receive power associated with the first set of channel measurement resources.

19. The method of claim 15, further comprising:
determining a spatial filter corresponding to the receive beam based at least in part on one or more sounding reference signal resource identifiers corresponding to the second set of channel measurement resources, wherein the one or more channel measurement resource identifiers comprise the one or more sounding reference signal resource identifiers.

20. The method of claim 14, further comprising:
transmitting control signaling indicating to the UE to transmit, with the plurality of reference signals, a plurality of channel characteristics associated with the first set of channel measurement resources; and
receiving the plurality of channel characteristics in a same signal as the plurality of reference signals, the plurality of channel characteristics comprising one or more of a reference signal receive power, a signal interference-to-noise ratio, a rank indicator, a channel quality indicator, or a precoding matrix indicator.

21. The method of claim 14, further comprising:
receiving a message indicating a capability of the UE to support reporting the information corresponding to the one or more channel characteristics associated with the first set of channel measurement resources, the second set of channel measurement resources, or the direction of reception for the communications, wherein receiving the plurality of reference signals indicating the information is based at least in part on the capability.

22. The method of claim 14, further comprising:
receiving a first channel state information report of a first priority; and
receiving a second channel state information report of a second priority, the second channel state information report comprising the plurality of reference signals, wherein the first priority is greater than the second priority.

23. The method of claim 14, wherein a first angular spread of a first reference signal of the plurality of reference signals associated with the second set of channel measurement resources is smaller than a second angular spread of a second reference signal of the plurality of reference signals associated with the first set of channel measurement resources.

24. The method of claim 14, wherein the plurality of reference signals comprise a channel state information-reference signal, a synchronization signal block, or both.

25. The method of claim 14, wherein the one or more channel characteristics associated with the first set of channel measurement resources, the second set of channel measurement resources, and the direction of reception for communications comprise one or more of a time domain channel characteristic of the plurality of reference signals, a spatial domain channel characteristic of the plurality of reference signals, or both.

26. A method for wireless communication at a user equipment (UE), comprising:
transmitting information associated with one or more channel measurement resources and a direction of reception for communications;
receiving signaling indicating a machine learning model for obtaining a channel characteristic prediction associated with the one or more channel measurement resources based at least in part on transmitting the information;
inputting, to the machine learning model, an input to obtain the channel characteristic prediction associated with the one or more channel measurement resources; and
receiving signaling based at least in part on obtaining the channel characteristic prediction associated with the one or more channel measurement resources.

27. The method of claim 26, further comprising:
inputting, to the machine learning model, one or more channel characteristics associated with the one or more channel measurement resources, the transmitted information, or both; and
obtaining the channel characteristic prediction associated with the one or more channel measurement resources, the transmitted information, or both based at least in part on the inputting.

28. The method of claim 26, further comprising:
transmitting a message indicating a capability of the UE to support transmitting the information, wherein transmitting the information is based at least in part on the capability.

29. The method of claim 26, further comprising:
transmitting the information according to a periodicity; and
receiving, according to the periodicity, additional signaling indicating an update to the machine learning model based at least in part on transmitting the information.

30. The method of claim 26, further comprising:
transmitting a first channel state information report of a first priority; and
transmitting a second channel state information report of a second priority, the second channel state information report comprising the information, wherein the first priority is greater than the second priority.

31. The method of claim 26, wherein the information comprises a phase coefficient associated with a radio-frequency chain, an amplitude coefficient associated with the radio-frequency chain, a phase coefficient associated with a phase shifter, an amplitude associated with the phase shifter, an antenna panel identifier associated with the direction of reception, an orientation of an antenna panel associated with the direction of reception, a target angle of arrival for the communications, or a zenith of arrival for the communications.

32. A method for wireless communication at a network entity, comprising:
receiving information associated with one or more channel measurement resources and a direction of reception for communications at a user equipment (UE);
training a machine learning model for obtaining a channel characteristic prediction based at least in part on inputting one or more channel characteristics and the information to the machine learning model to obtain the channel characteristic prediction; and
transmitting signaling indicating the machine learning model based at least in part on training the machine learning model.

33. The method of claim 32, further comprising:
receiving the information according to a periodicity;
inputting, according to the periodicity, the one or more channel characteristics and the information to the machine learning model to obtain the channel characteristic prediction, wherein the channel characteristic prediction comprises a reference signal receive power associated with the one or more channel measurement resources, a channel measurement resource identifier, or both; and
transmitting, according to the periodicity, additional signaling indicating an updated machine learning model based at least in part on inputting the one or more channel characteristics and the information to the machine learning model.

34. The method of claim 32, further comprising:
receiving a message indicating a capability of the UE to support transmitting the information, wherein receiving the information is based at least in part on the capability.

35. The method of claim 32, further comprising:
receiving a first channel state information report of a first priority; and
receiving a second channel state information report of a second priority, the second channel state information report comprising the information, wherein the first priority is greater than the second priority.

36. The method of claim 32, wherein the information comprises a phase coefficient associated with a radio-frequency chain, an amplitude coefficient associated with the radio-frequency chain, a phase coefficient associated with a phase shifter, an amplitude associated with the phase shifter, an antenna panel identifier associated with the direction of reception, an orientation of an antenna panel associated with the direction of reception, a target angle of arrival for the communications, or a zenith of arrival for the communications.
